(19) United States
(12) Patent Application Publication
(10) Pub. No.: US 2026/0107172 A1
(43) Pub. Date: Apr. 16, 2026

(54) METHOD, DEVICE AND COMPUTER STORAGE MEDIUM OF COMMUNICATION

(71) Applicant: NEC CORPORATION, Tokyo (JP)

(72) Inventors: Yukai GAO, Beijing (CN); Peng GUAN, Beijing (CN); Gang WANG, Beijing (CN)

(73) Assignee: NEC CORPORATION, Tokyo (JP)

(21) Appl. No.: 19/114,913

(22) PCT Filed: Sep. 29, 2022
(86) PCT No.: PCT/CN2022/122817

§ 371 Date: Mar. 25, 2025

(51) Int. Cl. H04W 24/10; H04W 72/0446

(52) U.S. Cl. CPC H04W 24/10; H04W 72/0446

(57) ABSTRACT

Embodiments of the present disclosure relate to methods, devices, and computer readable medium for communication. A time domain channel properties (TDCP) is transmitted from a terminal device to a network device. The set of parameters comprises at last one of: a maximum doppler shift, a doppler spread, a coherence time, a speed of the terminal device, correlation information on a plurality of time intervals among resources or resource sets for the TDCP report, an indication of the plurality of time intervals corresponding to a plurality of correlation values, or a unit of time interval. At least one of a value range, a step size or a number of bits for a first parameter from the set of parameters is based on at least one of a value of or a value range for a second parameter from the set of parameters. In this way, the information of channel properties can be designed and reported in the TDCP report. And in this way, the payload of the TDCP report may be reduced, thereby saving transmission resources for the TDCP report.

### TECHNICAL FIELD

Embodiments of the present disclosure generally relate to the field of telecommunication, and in particular, to methods, devices and computer storage media of communication for measurement report.

### BACKGROUND

Several technologies have been proposed to improve communication performances. For example, channel state information (CSI) may be transmitted. In wireless communications, CSI refers to known channel properties of a communication link. This information describes how a signal propagates from the transmitter to the receiver and represents the combined effect of, for example, scattering, fading, and power decay with distance. Moreover, multiple transmission reception point (TRP) has been proposed. And further studying on designing CSI enhancement for coherent joint transmission based on multi-TRP or CSI enhancement for high/medium velocities or CSI enhancement for time domain channel properties is needed.

Generally speaking, during the communication between the terminal device and the network device, the terminal device needs to report CSI feedback to the network device, such that the network device may understand the network condition and make a more proper subsequent schedule. In some scenarios, the terminal device moves at a high/medium velocity, which causes that the reported CSI feedback may be not available (i.e., out of date) for the future channel. Specifically, in the case of downlink multi-antenna transmission, the terminal device may measure a CSI-reference signal (CSI-RS) transmitted from the network device and report a recommended pre-coder matrix or an indication of the recommended pre-coder matrix and/or channel quality indicator, CQI, in a CSI report to the network device. The network device may then use the recommended pre-coder matrix when performing data transmission to the terminal device. However, in non-ideal conditions, the preferred pre-coder matrix and/or CQI may be time-sensitive, and the recommended pre-coder matrix and/or CQI may be not applicable anymore when the network device is scheduling downlink data transmission for the terminal device after a time period. Thus, it is desirable to provide a solution to support the CSI reporting in a scenario where the terminal device moves at a high/medium velocity. And it is desirable to provide a solution to support the reporting of the time domain channel properties based on measurement of CSI-RS or CSI-RS for tracking or tracking reference signal (TRS).

### SUMMARY

In general, embodiments of the present disclosure provide methods, devices and computer storage media for measurement report.

In a first aspect, there is provided a method performed by a terminal device. The method comprises transmitting, to a network device, a time domain channel properties (TDCP) report comprising a set of parameters. The set of parameters comprises at last one of: a maximum doppler shift, a doppler spread, a coherence time, a speed of the terminal device, correlation information on a plurality of time intervals among resources or resource sets for the TDCP report, an indication of the plurality of time intervals corresponding to a plurality of correlation values, or a unit of time interval. At least one of a value range, a step size or a number of bits for a first parameter from the set of parameters is based on at least one of a value of or a value range for a second parameter from the set of parameters.

In a second aspect, there is provided a method performed by a network device. The method comprises receiving, from a terminal device, a time domain channel properties (TDCP) report comprising a set of parameters. The set of parameters comprises at last one of: a maximum doppler shift, a doppler spread, a coherence time, a speed of the terminal device, correlation information on a plurality of time intervals among resources or resource sets for the TDCP report, an indication of the plurality of time intervals corresponding to a plurality of correlation values, or a unit of time interval. At least one of a value range, a step size or a number of bits for a first parameter from the set of parameters is based on at least one of a value of or a value range for a second parameter from the set of parameters.

In a third aspect, there is provided a terminal device. The terminal device comprises a processing unit; and a memory coupled to the processing unit and storing instructions thereon, the instructions, when executed by the processing unit, causing the terminal device to perform acts comprising: transmitting, to a network device, a time domain channel properties (TDCP) report comprising a set of parameters. The set of parameters comprises at last one of: a maximum doppler shift, a doppler spread, a coherence time, a speed of the terminal device, correlation information on a plurality of time intervals among resources or resource sets for the TDCP report, an indication of the plurality of time intervals corresponding to a plurality of correlation values, or a unit of time interval. At least one of a value range, a step size or a number of bits for a first parameter from the set of parameters is based on at least one of a value of or a value range for a second parameter from the set of parameters.

In a fourth aspect, there is provided a network device. The network device comprises a processing unit; and a memory coupled to the processing unit and storing instructions thereon, the instructions, when executed by the processing unit, causing the network device to perform acts comprising: receiving, from a terminal device, a time domain channel properties (TDCP) report comprising a set of parameters. The set of parameters comprises at last one of: a maximum doppler shift, a doppler spread, a coherence time, a speed of the terminal device, correlation information on a plurality of time intervals among resources or resource sets for the TDCP report, an indication of the plurality of time intervals corresponding to a plurality of correlation values, or a unit of time interval. At least one of a value range, a step size or a number of bits for a first parameter from the set of parameters is based on at least one of a value of or a value range for a second parameter from the set of parameters.

In a fifth aspect, there is provided a computer readable medium having instructions stored thereon, the instructions, when executed on at least one processor, causing the at least one processor to carry out the method according to the first aspect.

In a sixth aspect, there is provided a computer readable medium having instructions stored thereon, the instructions, when executed on at least one processor, causing the at least one processor to carry out the method according to the second aspect. Other features of the present disclosure will become easily comprehensible

through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications according to some embodiments of the present disclosure;

FIG. 3A-FIG. 3B show schematic diagrams of resource configurations according to some example embodiments of the present disclosure, respectively;

FIG. 4A-FIG. 4B show schematic diagrams of time intervals according to some example embodiments of the present disclosure, respectively;

FIG. 5 is a flowchart of an example method in accordance with an embodiment of the present disclosure;

FIG. 6 is a flowchart of an example method in accordance with an embodiment of the present disclosure; and

FIG. 7 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the following, the terms “transmission occasions”, “reception occasions”, “repetitions”, “transmission”, “reception”, “PDSCH transmission occasions”, “PDSCH repetitions”, “PUSCH transmission occasions”, “PUSCH repetitions”, “PUCCH occasions”, “PUCCH repetitions”, “repeated transmissions”, “repeated receptions”, “PDSCH transmissions”, “PDSCH receptions”, “PUSCH transmissions”, “PUSCH receptions”, “PUCCH transmissions”, “PUCCH receptions”, “RS transmission”, “RS reception”, “communication”, “transmissions” and “receptions” can be used interchangeably. The terms “TCI state”, “set of QCL parameter(s)”, “QCL parameter(s)”, “QCL assumption” and “QCL configuration” can be used interchangeably. The terms “TCI field”, “TCI state field”, and “transmission configuration indication” can be used interchangeably. The terms “transmission occasion”, “transmission”, “repetition”, “reception”, “reception occasion”, “monitoring occasion”, “PDCCH monitoring occasion”, “PDCCH transmission occasion”, “PDCCH transmission”, “PDCCH candidate”, “PDCCH reception occasion”, “PDCCH reception”, “search space”, “CORESET”, “multi-chance” and “PDCCH repetition” can be used interchangeably. In the following, the terms “PDCCH repetitions”, “repeated PDCCHs”, “repeated PDCCH signals”, “PDCCH candidates configured for same scheduling”, “PDCCH”, “PDCCH candidates” and “linked PDCCH candidates” can be used interchangeably. The terms “DCI” and “DCI format” can be used interchangeably. In some embodiments, the embodiments in this disclosure can be applied to PDSCH and PUSCH scheduling, and in the following, PDSCH scheduling is described as examples. For example, the embodiments in this disclosure can be applied to PUSCH by replacing “transmit” to “receive” and/or “receive” to “transmit”. The terms “PDSCH” and “PUSCH” can be used interchangeably. The terms “transmit” and “receive” can be used interchangeably. The terms “common beam”, “common beam update/indicate/indication”, “unified TCI state”, “unified TCI state update/indicate/indication”, “beam indication”, “TCI state(s) indication”, “TCI_state_r17”, “tci_Stateld_r17”, “TCI_state_r17 indicating a unified TCI state”, “TCI state shared/applied for all or subset of CORESETs and UE-dedicated reception on PDSCH”, “Rel-17 TCI state”, “TCI state with tci_Stateld_r17”, “TCI state configured for TCI state update in unified TCI framework”, “TCI state indicated in DCI for common beam update/indicate/indication” and “TCI state indicated in DCI and to be applied for all/subset of CORESETs and PDSCH” may be used interchangeably. The terms “subset of CORESETs”, “subset of TCI states”, “subset of unified TCI states”, “subset of downlink (unified) TCI states” and “subset of joint (unified) TCI states” may be used interchangeably. The terms “subset of PUCCHs”, “subset of TCI states”, “subset of unified TCI states”, “subset of uplink (unified) TCI states” and “subset of joint (unified) TCI states” may be used interchangeably. The terms “precoding matrix”, “precoding”, “beam”, “beamforming” and “precoder” may be used interchangeably. The terms “channel state information reference signal”, “CSI-RS”, “CSI-RS for tracking”, “CSI-RS for tracking reference signal”, “tracking reference signal”, “reference signal”, “RS” and “TRS” can be used interchangeably. The terms “time interval”, “lag”, “time lag”, “gap”, “time gap”, “delay” and “time delay” can be used interchangeably. The terms “UE”, “user equipment” and “terminal device” can be used interchangeably. The terms “resource set”, “a set of resources”, “resource” and “at least one resource” can be used interchangeably. The terms “report” and “reporting” can be used interchangeably.

In the context of the present application, the term “time domain channel properties (TDCP) report” may refer to a report that is transmitted from a terminal device to a network device and indicates properties about the time domain channel. TDCP reporting comprises stand-alone auxiliary feedback information to enable refinement of CSI reporting configuration, and/or codebook configuration parameters, and/or gNB-side CSI prediction. The term “doppler shift” or “doppler effect” may refer to a change in frequency of a wave in relation to an observer that is moving relative to the wave source. The term “doppler spread” used herein may refer to widening of the spectrum of a narrow band signal transmitted through a multipath propagation channel. The term “coherence time” used herein may be the inverse of the doppler spread and may be the measure of the speed at which channel characteristics change. The term “time interval” or “time lag” used herein may refer to a gap in time domain. The term “time interval” may be interchangeably used with the term “time lag”. The term “resource” may refer to a transmission resource in time domain and/or frequency domain. The term “slot” used herein refers to a dynamic scheduling unit. One slot comprises a predetermined number of symbols. For example, the number of symbols in one slot may be 12 or 14. The term “sub-slot” may refer to a number of symbols. For example, the number of symbols in one sub-slot may be 1, 2, 4, 7, 14. The sub-slot may comprise fewer symbols than one slot. The slot used herein may refer to a normal slot which comprises a predetermined number of symbols and also refer to a sub-slot which comprises fewer symbols than the predetermined number of symbols.

Embodiments of the present disclosure provide a solution on measurement report. According to embodiments of the present disclosure, a time domain channel properties (TDCP) is transmitted from a terminal device to a network device. The set of parameters comprises at last one of: a maximum doppler shift, a doppler spread, a coherence time, a speed of the terminal device, correlation information on a plurality of time intervals among resources or resource sets for the TDCP report, an indication of the plurality of time intervals corresponding to a plurality of correlation values, or a unit of time interval. At least one of a value range, a step size or a number of bits for a first parameter from the set of parameters is based on at least one of a value of or a value range for a second parameter from the set of parameters. In this way, the information of channel properties can be designed and reported in the TDCP report. And in this way, the payload of the TDCP report may be reduced, thereby saving transmission resources for the TDCP report.

Principles and implementations of the present disclosure will be described in detail below with reference to the figures.

### Example of Communication Network

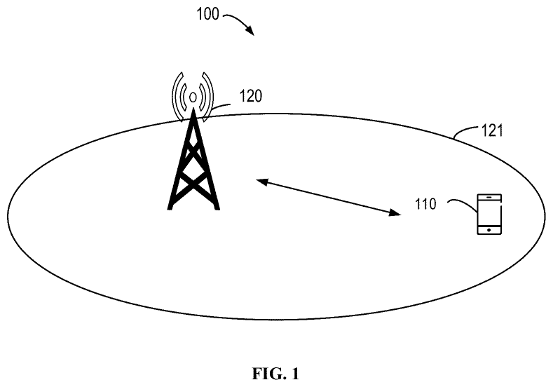

FIG. 1 illustrates a schematic diagram of an example communication network 100 in which some embodiments of the present disclosure can be implemented. As shown in FIG. 1, the communication network 100 may include a terminal device 110 and a network device 120. The network device 120 may provide a cell 121 to serve one or more terminal devices. In this example, the terminal device 110 is located in the cell 121 and is served by the network device 120.

In some embodiments, the network device 120 may be configured with one or two or three or four TRPs/panels. The serving area of the network device 120 is called as a cell 121. The network 100 may include any suitable number of devices adapted for implementing embodiments of the present disclosure. Although not shown, it would be appreciated that one or more terminal devices may be located in the cell 121 and served by the network device 120.

In some scenarios, carrier aggregation (CA) can be supported in the network 100, in which two or more CCs are aggregated in order to support a broader bandwidth. For example, in FIG. 1, the network device 120 may provide to the terminal device 110 a plurality of serving cells including one primary cell (Pcell or Pscell or Spcell) corresponding to a primary CC and at least one secondary cell (Scell) corresponding to at least one secondary CC. It is to be understood that the number of network devices, terminal devices and/or serving cells is only for the purpose of illustration without suggesting any limitations to the present disclosure. The network 100 may include any suitable number of network devices, terminal devices and/or serving cells adapted for implementing implementations of the present disclosure.

It is to be understood that the number of devices and cells in FIG. 1 is given for the purpose of illustration without suggesting any limitations to the present disclosure. The communication network 100 may include any suitable number of network devices and/or terminal devices and/or cells adapted for implementing implementations of the present disclosure.

In some embodiments, the terminal device 110 and the network device 120 may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

As mentioned above, further studying on designing CSI enhancement for coherent joint transmission based on multi-TRP is needed. Multi Input Multi Output (MIMO) may include features that facilitate utilization of a large number of antenna elements at base station for both sub-6 GHZ and over-6 GHz frequency bands. In some embodiments, it specifies CSI reporting enhancement for high/medium UE velocities by exploiting time-domain correlation/Doppler-domain information to assist DL precoding, targeting FR1 as follows: (1) Type-II codebook refinement, without modification to the spatial and frequency domain basis; (2) UE reporting of time-domain channel properties measured via CSI-RS for tracking.

In some solutions, a UE may receive (for example, a UE in RRC connected mode is expected to receive) a higher layer configuration of a NZP-CSI-RS-ResourceSet configured with higher layer parameter trs-Info. For a NZP-CSI-RS-ResourceSet configured with the higher layer parameter trs-Info, the UE shall assume the antenna port with the same port index of the configured NZP CSI-RS resources in the NZP-CSI-RS-ResourceSet is the same.—For frequency range 1, the UE may be configured with one or more NZP CSI-RS set(s), where a NZP-CSI-RS-ResourceSet consists of four periodic NZP CSI-RS resources in two consecutive slots with two periodic NZP CSI-RS resources in each slot. If no two consecutive slots are indicated as downlink slots by tdd-UL-DL-ConfigurationCommon or tdd-UL-DL-ConfigDedicated, then the UE may be configured with one or more NZP CSI-RS set(s), where a NZP-CSI-RS-ResourceSet consists of two periodic NZP CSI-RS resources in one slot.

In some embodiments, each CSI-RS resource (for example, CSI-RS for tracking) may be configured by the higher layer parameter NZP-CSI-RS-Resource with at least one of the following restrictions:—the time-domain locations of the two CSI-RS resources in a slot, or of the four CSI-RS resources in two consecutive slots (which are the same across two consecutive slots), as defined by higher layer parameter CSIRS-resourceMapping, is given by one of −I∈{8,4}, I∈{9,5}, or/∈{6,10} for frequency range 1 and frequency range 2, −I∈{4,0}, 1∈{5,1}, I∈{6,2}, I∈{7,3}, I∈{7,11}, I∈{8,12} or I∈{9,13} for frequency range 2.—a single port CSI-RS resource with density ρ=3 and higher layer parameter density configured by CSI-RS-ResourceMapping. In some embodiments, I may be the index of symbol within a slot. For example, I may be at least one of {0, 1, 2, 3, 4, 5, 6, 7, 8, 9, 10, 11, 12, 13}. For another example, I may be at least one of {0, 1, 2, 3, 4, 5, 6, 7, 8, 9, 10, 11}.

In some solutions, TRS-based TDCP reporting may comprise stand-alone auxiliary feedback information to enable refinement of CSI reporting configuration, and/or codebook configuration parameters, and/or (to be confirmed in RAN1 #110) gNB-side CSI prediction. The TRS-based TDCP reporting may not be conditioned on other uplink control information (UCI) parameters and not be reported together with CQI/PMI/RI/(CRI) associated with a codebook. This does not prevent TDCP reporting from being multiplexed with other UCI parameters on PUCCH and/or PUSCH. Aperiodic reporting is supported.

For TRS-based TDCP reporting, it may down select one of the following alternatives: AltA. Based on Doppler profile, for example, Doppler spread derived from the 2^{nd} moment of Doppler power spectrum, average Doppler shifts, Doppler shift per resource, maximum Doppler shift, relative Doppler shift, etc; AltB. based on time-domain correlation profile, for example, correlation within one TRS resource, correlation across multiple TRS resources and the correlation over one or more lags of TRS resource may be considered; the lags may be within one TRS burst or different TRS bursts; AltC: CSI-RS resource and/or CSI reporting setting configuration parameter(s) to assist network, for example, gNB configures UE with multiple choices on what to assist (e.g. two or more CSI-RS/report periodicities, or precoding schemes depending mainly on UE velocity), then UE report according to configuration; parameters correspond to CSI reporting periodicity, codebook type, etc. Different alternatives may or may not apply to different use cases.

However, details on TDCP reporting are not clear. For example, the reporting payload needs to be designed. If correlation is reported for TDCP, the quantized interval may be different for different time intervals/lags. Candidate TRS periodicities may be limited. In some embodiments, CSI-RS configuration for doppler domain codebook acquisition may be 4 slots interval. Lower interval may be not supported, larger interval may cause huge delay for PMI reporting.

In some solutions, it may propose correlation of TRS on different symbols. However, there are not details on reporting format. At least correlation of TRS symbols within a slot seems not needed, the correlation should be close to 1, otherwise, coherence time is too small, current system framework is not suitable.

In some solutions, it may propose to report the autocorrelation function for a number of autocorrelation lags, corresponding to the lags between TRS symbols in a single TRS-burst, as well as lags between different TRS bursts. This gives the most detailed information about the channel variation for over different lags. The signaling load for reporting the Autocorrelation for a small number of autocorrelation lags may be small. Autocorrelation function for a number of autocorrelation lags, corresponding to the lags between TRS symbols in a single TRS-burst as well as lags between different TRS bursts, is the best method for TRS based TDCP reporting. However, it still lacks details on reporting format.

Embodiments of the present disclosure will be described in detail below.

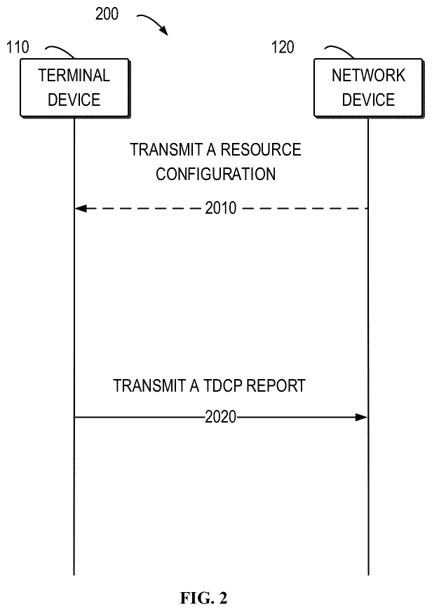

Reference is first made to FIG. 2, which shows a signaling chart illustrating process 200 among the terminal device and the network device according to some example embodiments of the present disclosure. Only for the purpose of discussion, the process 200 will be described with reference to FIG. 1. For example, the process 200 may involve the terminal device 110 and the network device 120.

In some embodiments, the network device 120 may transmit 2010 a resource configuration to the terminal device 110. In some embodiments, the terminal device 110 may be configured with at least one set of CSI-RS for tracking TRS, and the set of CSI-RS for tracking may be associated with a TDCP reporting or may be applied for reporting of one TDCP. In this case, the number of sets may be N, N is positive integer, for example, 1<=N<=8. In some embodiments, each set may comprise two CSI-RS resources in one slot. In some embodiments, each set may comprise four CSI-RS resources in two consecutive slots with two CSI-RS resources in each slot. In some embodiments, the time interval between two CSI-RS resource sets (for example, between the n-th resource set and (n+1)-th resource set) may be Xn slots or symbols. In some embodiments, n may be positive or non-negative integer. For example, 1<=n<=N−1. In some embodiments, Xn may be positive integer. For example, 1<=Xn<=8. For another example, 1<=Xn<=128. For another example, 1<=Xn<=1792. In some embodiments, Xn may be same or different for different values of n. In some embodiments, the time interval between the (n+1)-th resource set and the first resource set may be

$${\sum }_{i = 1}^{n} X i$$

slots. In some embodiments, the time interval between the n-th resource set and the m-th resource set may be Zn,m slots or symbols. In some embodiments, n may be positive or non-negative integer. In some embodiments, m may be positive or non-negative integer. In some embodiments, 1<=n<=N−1. In some embodiments, 1<=m<=N. In some embodiments, n<m<=N. In some embodiments, Zn,m may be positive integer. For example, 1<=Zn,m<=8. For another example, 1<=Zn,m<=128. For another example, 1<=Zn,m<=1792. In some embodiments, the time interval between the n-th resource set and the m-th resource set may be

$${\sum }_{i = n}^{m - 1} X i$$

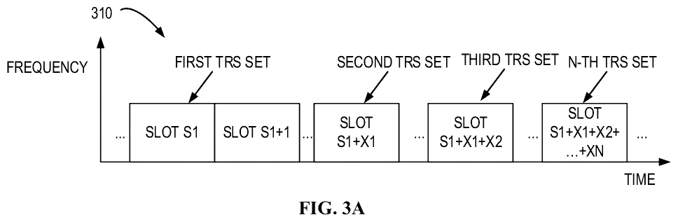

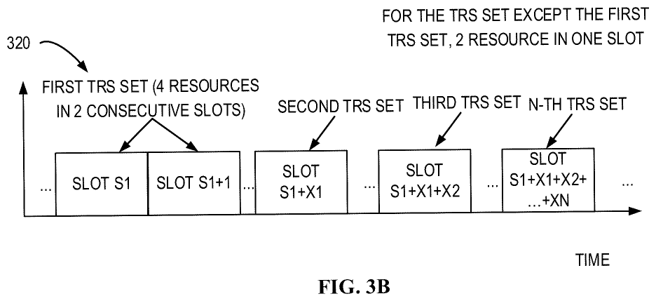

slots. In some embodiments, as shown in FIG. 3A, according to the resource configuration 310, the time interval between the first TRS set (for example, in slot S1 or the first slot for the first TRS set is S1) and the second TRS set (for example, in slot S1+X1 or the first slot for the second TRS set is S1+X1) may be X1, the time interval between the second TRS set (for example, in slot S1+X1 or the first slot for the second TRS set is S1+X1) and the third TRS set (for example, in slot S1+X1+X2 or the first slot for the third TRS set is S1+X1+X2) may be X2. The time interval between the first TRS set and the n-th TRS set (for example, in slot S1+X1+X2+ . . . +Xn or the first slot for the third TRS set is S1+X1+X2+ . . . +Xn) may be the sum of (X1, X2, . . . , Xn).

In some embodiments, the network device 120 may transmit the at least one CSI-RS for tracking resource set to the terminal device 110. In some embodiments, the network device 120 may transmit the at least one set of CSI-RS for tracking to the terminal device 110.

Alternatively, in some embodiments, the time interval between the n-th TRS resource set and the first resource set may be Wn slots or symbols. For example, 2<=n<=N. In some embodiments, Wn may be positive integer. For example, 1<=Wn<=8. For another example, 1<=Wn<=128. For another example, 1<=Wn<=1792. In some embodiments, as shown in FIG. 3B, according to the resource configuration 320, there may be 4 resources in two consecutive slots (for example, in slot S1 and slot S1+1) for the first TRS set. For the TRS set except the first TRS set, there may be two resources in one slot. For example, there may be two resources for the second TRS set (for example, in slot S1+X1), two resources for the third TRS set (for example, in slot S1+X1+X2) and two resources for the n-th TRS set (for example, in slot S1+X1+X2+ . . . +Xn). In some embodiments, S1 may be a non-negative integer. For example, 0<=S1<=1279.

In some embodiments, the terminal device 110 may be configured with one set of CSI-RS resources for tracking reference signal and the periodicity of the CSI-RS resources. In some embodiments, the periodicity values of TRS may be one of {10,20,40,80} ms or may be one of {1, 2, 3, 4, 5, 6, 8, 10, 12, 16, 20, 32, 40, 64, 80, 128, 160, 256, 320, 640, 1280, 2560, 5120} slots or may be one of {1, 2, 3, 4, 5, 6, 8, 12, 16, 24, 32, 48, 64} ms. In some embodiments, each set comprising two CSI-RS resources in one slot may be sufficient for TDCP reporting. And for configuration 1, the first resource set may comprise four CSI-RS resources in two consecutive slots (for fine time/frequency tracking). For example, for FR1. In this way, resources can be saved.

In some embodiments, the terminal device 110 may assume the antenna port with the same port index of the configured NZP CSI-RS resources in the multiple TRS sets is the same. In some embodiments, multiple TRS sets (for example, for one TDCP reporting) may have same power. For example, same powerControlOffset and powerControlOffsetSS given by NZP-CSI-RS-Resource value may be across all resources across all sets for one TDCP reporting.

In some embodiments, the QCL information (typeC and/or typeD source RS/SSB) for periodic NZP CSI-RS resources may be same applies to all resources across the multiple TRS sets for one TDCP reporting. Alternatively, or in addition, bandwidth and subcarrier location may be same for the CSI-RS resources across the multiple TRS sets for one TDCP reporting.

In some embodiments, no BWP switching may be expected at least within a burst of the multiple TRS sets for one TDCP reporting. Otherwise, the TDCP reporting may be dropped or not updated.

In some embodiments, the periodicity of the multiple TRS sets for one TDCP reporting may be different. For example, a first TRS set may have a first periodicity, and the other TRS sets may have a second periodicity. In some embodiments, the first periodicity may be no larger than the second periodicity. In some embodiments, the TDCP reporting periodicity may be same with the second or no less than the second periodicity. In some other embodiments, periodicity or interval for TDCP reporting may be no less than or larger than or a multiple of periodicity of TRS.

In some embodiments, TRS for TDCP may not applied for source RS for other RS/channels. In some embodiments, the first TRS resource set may can be applied. In some embodiments, the TDCP reporting may be per band or across CCs, for example, at least across CCs sharing a common unified TCI.

In some embodiments, the terminal device may be capable of performing TDCP measurement based on the configured at least one TRS resource or resource set for TDCP reporting/computation/calculation/measurement. In some embodiments, the physical layer of the terminal device may be capable of reporting TDCP measured over the measurement period.

Referring back to FIG. 2, the terminal device 110 transmits 2020 a TDCP report to the network device 120. In some embodiments, the TDCP report may comprise a set of parameters. In some embodiments, the set of parameters may comprise one or more of: a maximum doppler shift, a plurality of doppler shifts, a number of the plurality of doppler shifts, a doppler spread, a coherence time, a speed of the terminal device, a plurality of correlations on a plurality of time intervals, a plurality of indications of a plurality of time intervals, a number of the plurality of correlations, a number of the plurality of indications, a unit of time interval, a time interval unit, a unit of doppler shift, a unit of frequency, a frequency unit and a number of the plurality of time intervals.

In some embodiments, the number of the plurality of correlations may be at least one of {1,2,3,4,5,6,7,8,9,10}. In some embodiments, the number of the plurality of indications may be at least one of {1,2,3,4,5,6,7,8,9,10}. In some embodiments, the number of the plurality of time intervals may be at least one of {1,2,3,4,5,6,7,8,9,10}.

In some embodiments, the set of parameters may comprise one or more of: a maximum doppler shift, a doppler spread, a coherence time, a speed of the terminal device. In some embodiments, the set of parameters may comprise at least one correlation information on a plurality of time intervals among resources or resource sets for the TDCP report or a plurality of correlations on the plurality of time intervals. In some embodiments, the TDCP report may comprise at least one indication of the plurality of time intervals or a plurality of indications of the plurality of time intervals. Alternatively, in some embodiments, the plurality of time intervals among resources or resource sets for the TDCP report may be configured by the network device 120. In some embodiments, the TDCP report may comprise one or more of: an indication of the plurality of time intervals, a plurality of correlations on the plurality of time intervals, or a number of the plurality of correlations.

In some embodiments, the set of parameters may comprise at least one indication of the plurality of time intervals corresponding to a plurality of correlation values. In some embodiments, each time interval may correspond to a correlation value. For example, there may be a correlation value (e.g. C1, C1 is a decimal, 0<C1<1). In some embodiments, the correlation value may be preconfigured/predefined or configured by network device 120. In this case, in some embodiments, the terminal device 110 may report a time interval corresponding to the correlation value C1. For example, the correlation on the time interval may be same/similar as or close to the correlation value C1. In some embodiments, the TDCP report may indicate the number of the at least one indication and/or the number of the plurality of time intervals. In some embodiments, the set of parameters may comprise a unit of time interval. Alternatively, in some embodiments, the unit of time interval may be configured by the network device 120. For example, the value of the unit of time interval may be based on the value of subcarrier spacing. In some embodiments, the value of subcarrier spacing may be at least one of {15, 30, 60, 120, 240, 480, 960, 1920} KHz or at least one of {15000, 30000, 60000, 120000, 240000, 480000, 960000, 1920000} Hz.

In some embodiments, at least one of a value range, a step size or a number of bits for a first parameter from the set of parameters may be based on at least one of a value of or a value range for a second parameter from the set of parameters.

In some embodiments, a second correlation value or a range of the second correlation value or a step size of a range of the second correlation value on a second time interval may be based on a first correlation value on a first time interval. For example, a second correlation on a second time interval/lag may be based on a first correlation on a first time interval/lag (e.g. differential or fractional related to the first correlation).

In some embodiments, the plurality of time intervals or the unit of time interval may be based on one of: the maximum doppler shift, the doppler spread, the coherence time, or a first correlation. For example, the plurality of time intervals/lags and/or the unit of time intervals/lags may be based on the maximum doppler shift or doppler spread or coherence time or the first correlation.

In some embodiments, the plurality of time intervals may be preconfigured or configured by the network device 120. Alternatively, the plurality of time intervals may be determined based on an interval between different tracking reference signal (TRS) sets or based on an interval between different TRS symbols within a TRS set or based on an interval between different TRS occasion within a TRS set or based on an interval between different slots within a TRS set. For example, the plurality of time intervals/lags may be preconfigured or configured by network device 120. Alternatively, the plurality of time intervals/lags may be determined based on the intervals between different TRS sets and/or between different TRS symbols within a TRS set or between different slots within a TRS set. In some embodiments, the plurality of correlation values may be preconfigured or configured by the network device 120.

In some embodiments, the TDCP report may correspond to a group of TRS sets. For example, there may be at least one TDCP reporting, each corresponding to one group of TRS sets. In some embodiments, the terminal device may be configured with at least one TDCP report, and each TDCP report may correspond to a group of TRS sets. For example, for multi-TRP.

In some embodiments, a user equipment (UE) capability may indicate at least one of: whether the terminal device supports the TDCP support, the number of correlations, the maximum number of correlations, the number of the plurality of time intervals, the maximum number of the plurality of time intervals, the maximum number of the plurality of doppler shifts, a processing delay, or the number of TDCP reports.

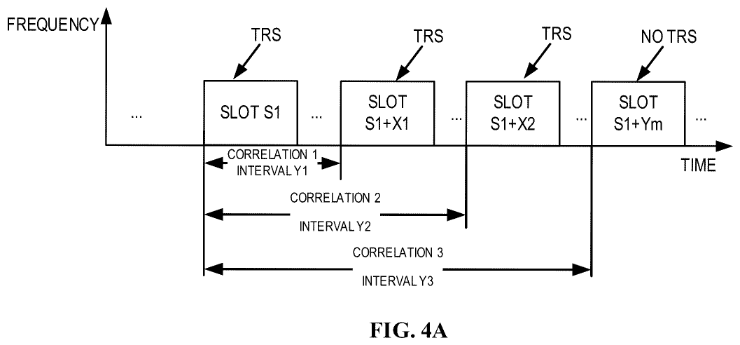

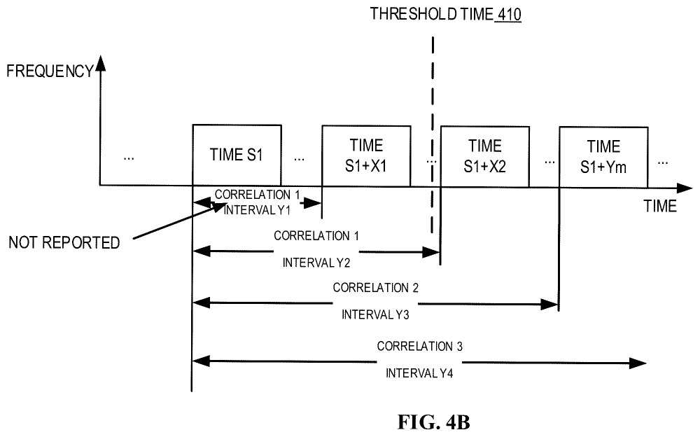

In some embodiments, a time interval corresponding to the TDCP report may be different from a timer interval of TRS. For example, as shown in FIG. 4A, the time intervals of TRS may be Xn, n=1,2 . . . . N. For example, N may be positive integer. For example, 1<=N<=8. The intervals of TDCP reporting may be Ym, for example, m=1,2 . . . . M. For example, M may be positive integer. For example, 1<=M<=16. The correlation value corresponding to time intervals Ym may be calculated/predicted by terminal device 110. In some embodiments, M may be larger than or no less than N. For example, M>=N. In some embodiments, the time intervals/lags Ym may be configured by network device 120 or determined based on at least one of Xn. For example, the time intervals Ym with m>N may be determined based on at least one value of Xn. In some embodiments, N may be different from M, or M>=N. For example, Y1=X1, Y2=X2, Y3=X2*P or X1*P. In this case, P may be a positive integer and may be configured by network device 120. In some embodiments, P may be determined based on the value of Xn or predetermined. In some embodiments, P may be a positive integer, and P may be at least one of {1, 2, 3, 4, 5, 6, 7, 8, 10, 12, 16, 20, 24, 30, 32, 40, 48, 60, 64, 80, 128, 256, 512}. For example, X1=1, X2=2, Y3=5. In this way, the TRS overhead may be reduced and more information of TDCP may be reported.

In some embodiments, the TDCP report may comprise a plurality of correlations on different time intervals. In some embodiments, the TDCP report may indicate an absolute value for each of the plurality of correlations. For example, TDCP reporting may comprise a plurality of correlations on different time intervals/lags, and for each one of the plurality of correlations, absolute value may be reported. In some embodiments, the value of a correlation may be at least one of V/10 or V/100 or V/20 or V/50 or V/1000. In some embodiments, V may be a positive integer or a non-negative integer. For example, 0<=V<=10. For another example, 0<=V<=100. For another example, 0<=V<=20. For another example, 0<=V<=50. For another example, 0<=V<=1000.

In some embodiments, at least one of: a value range, a bit size, or a step size for different fields for different correlations in the TDCP report may be different. For example, the step size may be at least one of {0.1, 0.2, 0.01, 0.02, 0.03, 0.04, 0.05}. In some embodiment, at least for the first correlation, there may be a state/value indicating the correlation is 1 or is >=a first threshold T1 (e.g. the first threshold may be 0.9 or 0.95 or 0.8). Table 1 shows an example of an absolute value for the first correlation. Table 2 shows an example of an absolute value for the second correlation. Table 3 shows an example of an absolute value for the n-th correlation. It is noted that numbers shown in Tables 1-3 are only examples not limitations.

TABLE 1
Absolute value for 1^{st} correlation

| Range | Bit size | Step size |
|---|---|---|
| {0.6, >=T1} | B1 | S1 |

TABLE 2
Absolute value for 2^{nd} correlation

| Range | Bit size | Step size |
|---|---|---|
| {0.4, 0.6} | B2 | S2 |

TABLE 3
Absolute value for n-th correlation

| Range | Bit size | Step size |
|---|---|---|
| {Rn1, Rn2} | Bn | Sn |

In some embodiments, the value of Rn1 and/or the value of Rn2 may be at least one of V/10 or V/100 or V/20 or V/50 or V/1000. In some embodiments, V may be a positive integer or a non-negative integer. For example, 0<=V<=10. For another example, 0<=V<=100. For another example, 0<=V<=20. For another example, 0<=V<=50. For another example, 0<=V<=1000. In some embodiments, the value of Rn2 may be larger than the value of Rn1.

In some embodiments, a value range for (n+1)-th correlation in the plurality of correlations may depend on a value for n-th correlation or a value for a first correlation in the plurality of correlations, where n is an integer. For example, if the first correlation is C1-1 or within a first range, the value range for the 2^{nd} correlation may be {R21_1, R22_1}, and if the first correlation is C1-2 or within a second range, the value range for the 2^{nd} correlation may be {R21_2, R22_2}. In some embodiments, R21_1 may be different from R21_2 and/or R22_1 may be different from R22_2. In some embodiments, the value of C1-1 and/or the value of C1-2 and/or the value of R21_1 and/or the value of R22_1 and/or the value of R21_2 and/or the value of R22_2 may be at least one of V/10 or V/100 or V/20 or V/50 or V/1000. In some embodiments, V may be a positive integer or a non-negative integer. For example, 0<=V<=10. For another example, 0<=V<=100. For another example, 0<=V<=20. For another example, 0<=V<=50. For another example, 0<=V<=1000. In some embodiments, the bit size for the value range of 2^{nd} correlation may be fixed or independent of the value of first correlation, for example, B2 or ceil(log 2(maximum (N2_p))), where N2_p may be the number of possible values for the 2^{nd} correlation corresponding to one value of first correlation. In some embodiments, B2 may be a positive integer. For example, 1<=B2<=16. In some embodiments, N2_p may be a positive integer. For example, 1<=N2_p<=1000. Table 4 shows an example of an absolute value for the first correlation. Table 5 shows an example of a first value or within a first sub-range. Table 6 shows an example of a second value or within a second sub-range. It is noted that numbers shown in Tables 4-6 are only examples not limitations.

TABLE 4
Absolute value for 1^{st} correlation

| Range | Bit size | Step size |
|---|---|---|
| {R11, R12} | B1 | S1 |

TABLE 5
Range for 2^{nd} correlation

{R21_1, R22_1}

TABLE 6
Range for 2^{nd} correlation

{R21_2, R22_2}

In some embodiments, the TDCP report may comprise a plurality of correlations on different time intervals. In this case, in some embodiments, the TDCP report may indicate an absolute value for a first correlation of the plurality of correlations and a differential value for other correlations in the plurality of correlations. For example, for the first correlation, absolute value for the first correlation, absolute value may be reported, and for other correlation(s) differential or fractional value may be reported. In this way, more information of TDCP may be reported.

In some embodiments, the value range and/or bit size and/or step size for different fields for different correlations (e.g. except the first correlation) may be different. For example, the step size may be at least one of {0.1, 0.2, 0.01, 0.02, 0.03, 0.04, 0.05}. In some embodiments, the fractional value may be at least one of {⅘, ¾, ⅔, ½, ⅓, ¼, ⅖, ⅗, ⅕}. In some embodiments, at least for the first correlation, there may be a state/value indicating the correlation is 1 or is >=a first threshold T1 (for example, the first threshold may be 0.9 or 0.95 or 0.85). In this way, more information of TDCP may be reported. Table 7 shows an example of an absolute value for the first correlation. Table 8 shows an example of differential/fractional value for the second correlation. It is noted that numbers shown in Tables 7 and 8 are only examples not limitations.

TABLE 7
Absolute value for 1^{st} correlation

| Range | Bit size | Step size |
|---|---|---|
| {R11, R12} | B1 | S1 |

TABLE 8
Differential/fractional value for 2^{nd} correlation

| Range | Bit size | Step size |
|---|---|---|
| {F21, F22} | B2 | S2 |

In some embodiments, the value range for (n+1)-th correlation may depend on the indicated value for the n-th correlation or for the first correlation. For example, if the first correlation is C1-1 or within a first range, the value range for the 2^{nd} correlation may be {R21_1, R22_1}, and if the first correlation is C1-2 or within a second range, the value range for the 2^{nd} correlation may be {R21_2, R22_2}. R21_1 may be different from R21_2 and/or R22_1 may be different from R22_2. In some embodiments, the value of C1-1 and/or the value of C1-2 and/or the value of R21_1 and/or the value of R22_1 and/or the value of R21_2 and/or the value of R22_2 may be at least one of V/10 or V/100 or V/20 or V/50 or V/1000. In some embodiments, V may be a positive integer or a non-negative integer. For example, 0<=V<=10. For another example, 0<=V<=100. For another example, 0<=V<=20. For another example, 0<=V<=50. For another example, 0<=V<=1000. In some embodiments, the bit size for the value range of 2^{nd} correlation may be fixed or independent of the value of first correlation, for example, B2 or ceil (log 2(maximum (N2_p))). N2_p may be the number of possible values for the 2^{nd} correlation corresponding to one value of first correlation. In some embodiments, B2 may be a positive integer. For example, 1<=B2<=16. In some embodiments, N2_p may be a positive integer. For example, 1<=N2_p<=1000. Table 9 shows an example of an absolute value for the first correlation. Table 10 shows an example of a first value or within a first sub-range. Table 11 shows an example of a second value or within a second sub-range. It is noted that numbers shown in Tables 9-11 are only examples not limitations.

TABLE 9
Absolute value for 1^{st} correlation

| Range | Bit size | Step size |
|---|---|---|
| {R11, R12} | B1 | S1 |

TABLE 10
Range for 2^{nd} correlation
{R21_1, R22_1}

TABLE 11
Range for 2^{nd} correlation
R21_2, R22_2}

In some embodiments, the TDCP report may comprise a plurality of correlations on different time intervals and a doppler parameter. In some embodiments, the doppler parameter may comprise one or more: the maximum doppler shift, the doppler spread, or the coherence time or the speed of the terminal device. In some embodiments, at least one of: a value range, a bit size, or a step size for different fields for different correlations in the TDCP report depends on the doppler parameter. For example, the value range and/or bit size and/or step size and/or the time intervals/lags for different fields for different correlations may depend on the value of the doppler parameter. For example, the correlation no later than or after the coherence time may need to be reported. The correlation before the coherence time may not needed to be reported. The first correlation may correspond to the time interval/lag larger than the threshold time (e.g. coherence time). Starting from the first correlation, the plurality of correlations may be determined. For example, as shown in FIG. 4B, the correlation before the threshold time 410 may not be reported. In this way, more information of TDCP may be reported. Table 12 shows an example of a first value or within a first sub-range. Table 13 shows an example of a second value or within a second sub-range. It is noted that numbers shown in Tables 12 and 13 are only examples not limitations.

TABLE 12
Range for n-th correlation
{Rn1_1, Rn2_1} or {Rn1, Rn2}

TABLE 13
Range for n-th correlation
{Rn1_2, Rn2_2} or {Rn3, Rn4}

In some embodiments, the value of C1-1 and/or the value of C1-2 and/or the value of Rn1_1 and/or the value of Rn2_1 and/or the value of Rn1_2 and/or the value of Rn2_2 and/or the value of Rn1 and/or the value of Rn2 and/or the value of Rn3 and/or the value of Rn4 may be at least one of V/10 or V/100 or V/20 or V/50 or V/1000. In some embodiments, n is a positive or non-negative integer. For example, 0<=n<=8. In some embodiments, V may be a positive integer or a non-negative integer. For example, 0<=V<=10. For another example, 0<=V<=100. For another example, 0<=V<=20. For another example, 0<=V<=50. For another example, 0<=V<=1000. In some embodiments, Rn2_2 may be larger than Rn1_2. In some embodiments, Rn2_1 may be larger than Rn1_1. In some embodiments, Rn2 may be larger than Rn1. In some embodiments, Rn4 may be larger than Rn3.

In some embodiments, the TDCP report may comprise the plurality of time intervals corresponding to the plurality of correlation values. Each time interval may correspond to a correlation value. For example, there may be a plurality of correlation values (e.g. Cn, Cn is a decimal, 0<Cn<1, and different from each other) or a plurality of correlation ranges (e.g. [Rn1, Rn2] [0.9-1], [0.8-0.9], . . . ). In some embodiments, the value of Cn and/or the value of Rn1 and/or the value of Rn2 may be at least one of V/10 or V/100 or V/20 or V/50 or V/1000. In some embodiments, n is a positive or non-negative integer. For example, 0<=n<=8. In some embodiments, V may be a positive integer or a non-negative integer. For example, 0<=V<=10. For another example, 0<=V<=100. For another example, 0<=V<=20. For another example, 0<=V<=50. For another example, 0<=V<=1000. The correlation value may be preconfigured/predefined or configured by the network device 120. The terminal device 110 may report a time interval/lag. The correlation on the time interval/lag may be same/similar as the correlation value Cn. In some embodiments, the number of correlation values/ranges and/or the number of time intervals/lags may be configured by the network device 120 or predefined or reported by the terminal device 110. In some embodiments, the value of time interval/lag may be Ln. Ln may be positive integer, for example, 1<=Ln<=128. In some embodiments, the unit of time intervals/lags may be configured by network device 120 or predefined or reported by the terminal device 110. For example, the unit may be a number of symbols/slots. In some embodiments, there may be no need of TRS transmission on the slots corresponding to the reported time intervals/lags. In this way, more information of TDCP may be reported.

In some embodiments, absolute/differential/fractional values may be applied, dependence of first value may be applied. In some embodiments, the TDCP report may comprise an absolute value for each time interval. In this way, more information of TDCP may be reported. Table 14 shows an example of absolute value for each time interval. It is noted that Table 14 is only an example not limitation.

TABLE 14

| | | |
|---|---|---|
| First time | Corresponding to C1 | {<1, 1, 2, 4, 8, 10, 12, |
| interval/lag | | 14, 16} |
| Second time | Corresponding to C2 | {10, 12 . . . } |
| interval/lag | | |

In some embodiments, the value of C1 and/or the value of C2 may be at least one of V/10 or V/100 or V/20 or V/50 or V/1000. In some embodiments, V may be a positive integer or a non-negative integer. For example, 0<=V<=10. For another example, 0<=V<=100. For another example, 0<=V<=20. For another example, 0<=V<=50. For another example, 0<=V<=1000. In some embodiments, the value of a time interval may be Xn or Yn or Wn or Zm,n or Ym slots or symbols. In some embodiments, 1<=Xn<=1792 or 1<=Yn<=1792 or 1<=Wn<=1792 or 1<=Zm,n<=1792 or 1<=Ym<=1792.

In some embodiments, a value range for (n+1)-th time interval in the plurality of time intervals may depend on a value for n-th time interval or a value for a first time interval in the plurality of time intervals, where n is an integer. In this way, more information of TDCP may be reported. Table 15 shows an example of a first value or within a first sub-range. Table 16 shows an example of a second value or within a second sub-range. It is noted that numbers shown in Tables 15 and 16 are only examples not limitations.

TABLE 15
Range for n-th time interval/lag
{Ln1_1, Ln2_1}

TABLE 16
Range for n-th time interval/lag
{Ln1_2, Ln2_2}

In some embodiments, the TDCP report may indicate an absolute value for a first time interval of the plurality of time intervals and a differential value for other time intervals in the plurality of time intervals. For example, a value range for (n+1)-th time interval in the plurality of time intervals may depend on a value for n-th time interval or a value for a first time interval in the plurality of time intervals, where n is an integer. In this way, more information of TDCP may be reported. Table 17 shows an example of a first value or within a first sub-range. Table 18 shows an example of a second value or within a second sub-range. It is noted that numbers shown in Tables 17 and 18 are only examples not limitations.

TABLE 17
Range for n-th time interval/lag
{Ln1_1, Ln2_1}

TABLE 18
Range for n-th time interval/lag
{Ln1_2, Ln2_2}

In some embodiments, the value of Ln1_1 and/or the value of Ln2_1 and/or the value of Ln1_2 and/or the value of Ln2_2 may be a positive integer, and within a range of 1 to 1792. In some embodiments, 1<=Ln1_1<=1792. In some embodiments, or 1<=Ln2_1<=1792. In some embodiments, 1<=Ln1_2<=1792. In some embodiments, 1<=Ln2_2<=1792. In some embodiments, Ln2_1 may be larger than Ln1_1. In some embodiments, Ln2_2 may be larger than Ln1_2.

In some embodiments, the TDCP report may comprise one or more of: an indication of whether there is an intra-set correlation, or an indication of intra-set or inter-set correlation. TDCP reporting may comprise a unit of time interval/lag (or an indication of whether there is intra-set correlation or not or an indication of intra-set or inter-set correlation) and a plurality of time intervals/lags corresponding to a plurality of correlation values. Each time interval/lag may correspond to a correlation value. In some embodiments, the unit of time interval/lag may be at least one of {1, 2, 3, 4, 5, 6, 8, 10, 12, 16, 20, 24, 40, 48, 60, 64, 80} slots. In some embodiments, at least one of: a value range, a bit size, or a step size for different fields for different time intervals depends on the unit of time interval. In this way, more information of TDCP may be reported. Table 19 shows an example of a first value or within a first sub-range. Table 20 shows an example of a second value or within a second sub-range. It is noted that numbers shown in Tables 19 and 20 are only examples not limitations.

TABLE 19
Range for n-th time interval/lag
{Ln1_1, Ln2_1}

TABLE 20
Range for n-th time interval/lag
{Ln1_2, Ln2_2}

In some embodiments, the TDCP report may comprise a plurality of doppler shifts. For example, the plurality of doppler shifts may be arranged in an increasing order of delays of multiple paths between the terminal device and the network device. In other words, TDCP reporting may comprise a plurality of doppler shifts (fd_1, fd_2, . . . fd_n), where the doppler shifts may be in increasing order of delays of multiple paths. In some embodiments, the value of at least one of (fd_1, fd_2, . . . fd_n) may be a positive integer. For example, 1<=fd_n<=15000. For another example, 1<=fd_n<=1500. For example, 1<=fd_n<=1000. In some embodiments, n may be a positive or a non-negative integer. For example, 0<=n<=20. Actually, in this case, it can be regarded as reporting a plurality of doppler bases with one spatial domain basis (single-port TRS) and reciprocity-based frequency domain bases, while no reporting of amplitude and/or phase coefficients for the doppler bases. In this way, more information of TDCP may be reported.

In some embodiments, an n-th one of the plurality of doppler shifts may be a doppler shift of the channel response at the n-th path delay of the resource elements that carry the TRS signal configured for the measurement. For example, the first one of the plurality of doppler shifts may be a doppler shift of the channel response at the first path delay of the resource elements that carry the TRS signal configured for the measurement. For another example, doppler shift for the first path delay may be the doppler shift corresponding to the first detected path in time. For another example, doppler shift for the n-th path delay may be the doppler shift corresponding to the n-th detected path in time. In some embodiments, n may be a positive integer. For example, 1<=n<=20.

In some embodiments, the reference point for the doppler shift may be the antenna connector of the UE. For example, for frequency range 1. In some embodiments, doppler shift may be measured based on the combined signal from antenna elements corresponding to a given receiver branch. For example, for frequency range 2.

In some embodiments, if receiver diversity is in use by the UE for doppler shift measurements, the reported doppler shift value for the first and additional measurements may be provided for the same receiver branch(es) as applied for doppler shift measurements. For example, for frequency range 1 and 2.

In some embodiments, the value of a doppler shift or the value of a doppler spread or the value of a maximum doppler shift may be Fd Hz. In some embodiments, Fd may be a positive integer. For example, 1<=Fd<=15000. For another example, 1<=Fd<=1500. For example, 1<=Fd<=1000.

In some embodiments, the TDCP report may comprise an absolute value for each of the plurality of doppler shifts. In some other embodiments, the TDCP report may indicate an absolute value for a first doppler shift of the plurality of doppler shifts and (n+1) doppler shift is a differential value related to the first doppler shift or related to n-th doppler shift, where n is an integer. The differential value range may comprise both negative and positive values. In this way, more information of TDCP may be reported.

In some embodiments, the TDCP report may comprise a unit of doppler shift, and each of the plurality of doppler shifts may be based on the unit of doppler shift and a corresponding doppler shift field value in the TDCP report. In some embodiments, the TDCP reporting may also comprise a unit of doppler shift. In some embodiments, the unit of doppler shift may be Ud. In some embodiments, Ud may be a positive integer. For example, 1<=Ud<=15000. For another example, 1<=Ud<=1500. For another example, 1<=Ud<=100. For another example, Ud may be at least one of {1, 10, 100, 20, 40, 50, 60, 80, 200}. In some embodiments, each doppler shift is based on the unit of doppler shift and a corresponding doppler shift field value. In some embodiments, the doppler shift may be related to subcarrier spacing (SCS, i.e., μ) or a ratio of SCS. For example, the unit of doppler shift may be a ratio of SCS. Alternatively, the unit of doppler shift may be related to μ. In this way, more information of TDCP may be reported. In some embodiments, the ratio of SCS may be R. In some embodiments, R may be a positive integer. For example, 10<=R<=15000. In some embodiments, the value of ratio of SCS may be based on the value of SCS. For example, if a first SCS is larger than a second SCS, the first ratio of the first SCS may be larger than the second ratio of the second SCS.

In some embodiments, the terminal device may be configured with a value of SCS and/or a value of an indication for SCS (For example, u). In some embodiments, μ may be a non-negative integer. For example, μ may be at least one of {0, 1, 2, 3, 4, 5, 6}. In some embodiments, μ=0 may correspond to SCS 15 KHz. In some embodiments, μ=1 may correspond to SCS 30 KHz. In some embodiments, μ=2 may correspond to SCS 60 KHz. In some embodiments, μ=3 may correspond to SCS 120 KHz. In some embodiments, μ=4 may correspond to SCS 240 KHz. In some embodiments, μ=5 may correspond to SCS 480 KHz. In some embodiments, μ=6 may correspond to SCS 960 KHz.

In some embodiments, the TDCP report may have a higher priority than a channel state information (CSI) report. For example, the TDCP reporting may have higher priority than other CSI reporting. In some embodiments, the other CSI reporting maybe except at leas one of: layer 1 reference signal received power (L1-RSRP), L1-sinal interference noise ratio (SINR) reporting, or a doppler based codebook reporting. For example, periodic/semi-persistent (P/SP) TDCP reporting may have higher priority than SP/aperiodic (AP) CSI reporting (for example, the CSI reporting may be at least one of: a precoding matrix indicator (PMI) reporting, a rank indicator (RI) reporting, a layer indicator (LI) reporting, a channel quality indicator (CQI) reporting and a CSI-RS resource indicator (CRI) reporting. For another example, the CSI reporting may not be L1-RSRP/L1-SINR and/or doppler based codebook/PMI reporting). For example, periodic TDCP reporting may have higher priority than periodic reporting of a first CSI and/or semi-persistent reporting of the first CSI and/or aperiodic reporting of the first CSI. For another example, semi-persistent TDCP reporting may have higher priority than periodic reporting of a first CSI and/or semi-persistent reporting of the first CSI and/or aperiodic reporting of the first CSI. For another example, aperiodic TDCP reporting may have higher priority than periodic reporting of a first CSI and/or semi-persistent reporting of the first CSI and/or aperiodic reporting of the first CSI. In some embodiments, the first CSI reporting may be at least one of: a precoding matrix indicator (PMI) reporting, a rank indicator (RI) reporting, a layer indicator (LI) reporting, a channel quality indicator (CQI) reporting and a CSI-RS resource indicator (CRI) reporting. In some embodiments, the CSI reporting may not be L1-RSRP/L1-SINR and/or doppler based codebook/PMI reporting. In some embodiments, TDCP may have lower priority than CRI and/or synchronization signal block (SSB) resource indicator (SSB-RI) and/or L1-RSRP and/or L1-SINR reporting in same or across different time domain behavior. In some other embodiments, TDCP may have lower priority than doppler based codebook/PMI reporting in same or across different time domain behavior. In some embodiments, the time domain behavior may comprise at least one of: aperiodic, semi-persistent and periodic. In this way, TDCP may be reported more efficiently.

In some embodiments, the TDCP may comprise at least one correlation or indication that is associated with a CSI reference signal (CSI-RS) or CSI configuration. In other words, TDCP reporting may be at least one correlation or an indication. In this case, the indication may be a suggestion for CSI-RS or CSI configuration. In some embodiments, for correlation, the value range may be {0-1}. For example, the value range for correlation may be at least one of {0, 0.1, 0.2, 0.3, 0.4, 0.5, 0.6, 0.7, 0.8, 0.9, 1} Alternatively, for the indication, the value may be {⅛, ¼, ½, 1, 2, 4, 8, 16, 32, 64, 128}. In some embodiments, the indication may be combined with CSI Reference Signal Resource Indicator (CRI) for a corresponding CSI-RS. For example, the indication value may be the suggestion for the periodicity coefficient of CSI-RS or CSI reporting. In some embodiments, for TDCP, there may be only one bit, for example, {0,1}. Only as an example, “0” may indicate current configuration is OK, and “1” may indicate CSI-RS or CSI reporting periodicity may be updated/reduced. In this way, CSI configuration may be selected properly. Table 21 shows an example of correlation index and value. Table 22 shows an example of indication index and value. It is noted that Tables 21 and 22 are only examples not limitations.

TABLE 21

| Correlation index | value |
|---|---|
| 0 | <0.4 |
| 1 | 0.5 |
| 2 | 0.6 |
| 3 | 0.7 |
| 4 | 0.8 |
| 5 | >=0.9 |

TABLE 22

| Indication index | value |
|---|---|
| 0 | ⅛ |
| 1 | ¼ |
| 2 | ½ |
| 3 | 1 |
| 4 | 2 |
| 5 | 4 |
| 6 | 8 |
| 7 | 16 |

In some embodiments, a first processing time for the TDCP report may comprise at least one of: a total number of CSI-RS resources in multiple TRS sets for the TDCP report, a total number of time intervals for the TDCP report, a number of CSI-RS resources in a TRS set for the TDCP report multiplying a value, where the value is configured by the network device or preconfigured. For example, regarding TDCP processing, for a CSI report with CSI-ReportConfig with higher layer parameter reportQuantity set to ‘tdcp’ (or ‘cri-tdcp’), O_{CPU}μ=Y, where Y may be at least one of: the total number of CSI-RS resources in the multiple TRS sets; the total number of time intervals/lags for TDCP reporting; the number of CSI-RS resources in the TRS set (e.g. in case of only one TRS set for TDCP reporting) multiplies a first value, wherein the first value may be configured by network device or predefined (e.g. the number of occasions of TRS for TDCP reporting). In this way, TDCP may be processed properly.

In some embodiments, a second processing time for coherent joint transmission (CJT) may comprise a combination of a number of central processing units (CPUs) occupied by a set of CSI-RS resources for CJT and a second value, where the second value is 0 or a number of single-transmission reception point (TRP) hypothesis. For example, for CSI for CJT processing, O_{CPU}μ=Y+M, where Y may be the number of CPUs occupied by the set of CSI-RS resources for CJT (subject to at least one of UE capabilities]) and M may be 0 or number of single-TRP hypothesis. In this way, TDCP may be processed properly.

In some embodiments, a third processing time for a velocity processing may comprise a combination of a number of CPUs occupied by a set of CSI-RS resource for the velocity and a third value. Alternatively, the third processing time may comprise a combination of a number of CSI-RS occasions in a CSI-RS set for the velocity and the third value, and where the third value is a predetermined number. For example, for CSI for high/medium velocities processing, O_{CPU}μ=Y+M, where Y may be the number of CPUs occupied by the sets of CSI-RS resources for high/medium velocities (or by the number of CSI-RS occasions in a CSI-RS set for high/medium velocities) subject to at least one of UE capabilities and M may be 0 or 1. In this way, TDCP may be processed properly.

In some embodiments, there may be a UE capability indicating whether the UE supports speed information reporting. For example, upon request from the network device. In some embodiments, if the terminal device supports speed information reporting, the TDCP reporting may comprise a first set of parameters, and if the terminal device does not support speed information reporting, the TDCP reporting may comprise a second set of parameters. In some embodiments, the second set of parameters may comprise the first set of parameters and at least one of: a maximum doppler shift, doppler spread, coherence time and a speed value of the terminal device.

FIG. 5 shows a flowchart of an example method 500 in accordance with an embodiment of the present disclosure. The method 500 can be implemented at any suitable terminal devices. Only for the purpose of illustrations, the method 500 can be implemented at a terminal device 110 as shown in FIG. 1.

In some embodiments, at block 510, the terminal device 110 may receive a resource configuration from the network device 120. In some embodiments, the terminal device 110 may be configured with at least one set of CSI-RS for tracking TRS and the set of CSI-RS for tracking may be associated with a TDCP reporting or may be applied for reporting of one TDCP. In this case, the number of sets may be N, N is positive integer, for example, 1<=N<=8. Each set may comprise two CSI-RS resources in one slot or four CSI-RS resources in two consecutive slots with two CSI-RS resources in each slot. The time interval between two CSI-RS resource sets (for example, between the n-th resource set and (n+1)-th resource set) may be Xn slots or symbols. In some embodiments, n may be positive or non-negative integer. For example, 1<=n<=N−1. In some embodiments, Xn may be positive integer. For example, 1<=Xn<=8. For another example, 1<=Xn<=128. For another example, 1<=Xn<=1792. In some embodiments, Xn may be same or different for different values of n. In some embodiments, the time interval between the (n+1)-th resource set and the first resource set may be

$${\sum }_{i = 1}^{n} X i$$

slots. In some embodiments, the time interval between the n-th resource set and the m-th resource set may be Zn,m slots or symbols. In some embodiments, n may be positive or non-negative integer. In some embodiments, m may be positive or non-negative integer. In some embodiments, 1<=n<=N−1. In some embodiments, 1<=m<=N. In some embodiments, n<m<=N. In some embodiments, Zn,m may be positive integer. For example, 1<=Zn,m<=8. For another example, 1<=Zn,m<=128. For another example, 1<=Zn,m<=1792. In some embodiments, the time interval between the n-th resource set and the m-th resource set may be

$${\sum }_{i = n}^{m - 1} X i$$

slots.

In some embodiments, the network device 120 may transmit the at least one CSI-RS for tracking resource set to the terminal device 110. In some embodiments, the network device 120 may transmit the at least one set of CSI-RS for tracking to the terminal device 110.

Alternatively, in some embodiments, the time interval between the n-th TRS resource set and the first resource set may be Wn slots or symbols. For example, 2<=n<=N. In some embodiments, Wn may be positive integer. For example, 1<=Wn<=8. For another example, 1<=Wn<=128. For another example, 1<=Wn<=1792.

In some embodiments, the terminal device 110 may be configured with one set of CSI-RS resources for tracking reference signal and the periodicity of the CSI-RS resources. In some embodiments, the periodicity values of TRS may be one of {10,20,40,80} ms or may be one of {1, 2, 3, 4, 5, 6, 8, 10, 12, 16, 20, 32, 40, 64, 80, 128, 160, 256, 320, 640, 1280, 2560, 5120} slots or may be one of {1, 2, 3, 4, 5, 6, 8, 12, 16, 24, 32, 48, 64} ms. In some embodiments, each set comprising two CSI-RS resources in one slot may be sufficient for TDCP reporting. And for configuration 1, the first resource set may comprise four CSI-RS resources in two consecutive slots (for fine time/frequency tracking). In this way, resources can be saved.

In some embodiments, the terminal device 110 may assume the antenna port with the same port index of the configured NZP CSI-RS resources in the multiple TRS sets is the same. In some embodiments, multiple TRS sets (for example, for one TDCP reporting) may have same power. For example, same powerControlOffset and powerControlOffsetSS given by NZP-CSI-RS-Resource value may be across all resources across all sets for one TDCP reporting.

In some embodiments, the QCL information (typeC and/or typeD source RS/SSB) for periodic NZP CSI-RS resources may be same applies to all resources across the multiple TRS sets for one TDCP reporting. Alternatively, or in addition, bandwidth and subcarrier location may be same for the CSI-RS resources across the multiple TRS sets for one TDCP reporting.

In some embodiments, no BWP switching may be expected at least within a burst of the multiple TRS sets for one TDCP reporting. Otherwise, the TDCP reporting may be dropped or not updated.

In some embodiments, the periodicity of the multiple TRS sets for one TDCP reporting may be different. For example, a first TRS set may have a first periodicity, and the other TRS sets may have a second periodicity. In some embodiments, the first periodicity may be no larger than the second periodicity. In some embodiments, the TDCP reporting periodicity may be same with the second or no less than the second periodicity. In some other embodiments, periodicity or interval for TDCP reporting may be no less than or larger than or a multiple of periodicity of TRS.

In some embodiments, TRS for TDCP may not applied for source RS for other RS/channels. In some embodiments, the first TRS resource set may can be applied. In some embodiments, the TDCP reporting may be per band or across CCs, for example, at least across CCs sharing a common unified TCI.

In some embodiments, the terminal device may be capable of performing TDCP measurement based on the configured at least one TRS resource or resource set for TDCP reporting/computation/calculation/measurement. In some embodiments, the physical layer of the terminal device may be capable of reporting TDCP measured over the measurement period.

At block 520, the terminal device 110 transmits a TDCP report to the network device 120. In some embodiments, the TDCP report may comprise a set of parameters. In some embodiments, the set of parameters may comprise one or more of: a maximum doppler shift, a plurality of doppler shifts, a number of the plurality of doppler shifts, a doppler spread, a coherence time, a speed of the terminal device, a plurality of correlations on a plurality of time intervals, a plurality of indications of a plurality of time intervals, a number of the plurality of correlations, a number of the plurality of indications, a unit of time interval, a time interval unit, a unit of doppler shift, a unit of frequency, a frequency unit and a number of the plurality of time intervals.

In some embodiments, the number of the plurality of correlations may be at least one of {1,2,3,4,5,6,7,8,9,10}. In some embodiments, the number of the plurality of indications may be at least one of {1,2,3,4,5,6,7,8,9,10}. In some embodiments, the number of the plurality of time intervals may be at least one of {1,2,3,4,5,6,7,8,9,10}.

In some embodiments, the set of parameters may comprise one or more of: a maximum doppler shift, a doppler spread, a coherence time, a speed of the terminal device. In some embodiments, the set of parameters may comprise at least one correlation information on a plurality of time intervals among resources or resource sets for the TDCP report or a plurality of correlations on the plurality of time intervals. In some embodiments, the TDCP report may comprise at least one indication of the plurality of time intervals or a plurality of indications of the plurality of time intervals. Alternatively, in some embodiments, the plurality of time intervals among resources or resource sets for the TDCP report may be configured by the network device 120. In some embodiments, the TDCP report may comprise one or more of: an indication of the plurality of time intervals, a plurality of correlations on the plurality of time intervals, or a number of the plurality of correlations.

In some embodiments, the set of parameters may comprise at least one indication of the plurality of time intervals corresponding to a plurality of correlation values. In some embodiments, each time interval may correspond to a correlation value. For example, there may be a correlation value (e.g. C1, C1 is a decimal, 0<C1<1). In some embodiments, the correlation value may be preconfigured/predefined or configured by network device 120. In this case, in some embodiments, the terminal device 110 may report a time interval corresponding to the correlation value C1. For example, the correlation on the time interval may be same/similar as or close to the correlation value C1. In some embodiments, the TDCP report may indicate the number of the at least one indication and/or the number of the plurality of time intervals. In some embodiments, the set of parameters may comprise a unit of time interval. Alternatively, in some embodiments, the unit of time interval may be configured by the network device 120. For example, the value of the unit of time interval may be based on the value of subcarrier spacing. In some embodiments, the value of subcarrier spacing may be at least one of {15, 30, 60, 120, 240, 480, 960, 1920} KHz or at least one of {15000, 30000, 60000, 120000, 240000, 480000, 960000, 1920000} Hz.

In some embodiments, at least one of a value range, a step size or a number of bits for a first parameter from the set of parameters may be based on at least one of a value of or a value range for a second parameter from the set of parameters.

In some embodiments, a second correlation value or a range of the second correlation value or a step size of a range of the second correlation value on a second time interval may be based on a first correlation value on a first time interval. For example, a second correlation on a second time interval/lag may be based on a first correlation on a first time interval/lag (e.g. differential or fractional related to the first correlation).

In some embodiments, the plurality of time intervals or the unit of time interval may be based on one of: the maximum doppler shift, the doppler spread, the coherence time, or a first correlation. For example, the plurality of time intervals/lags and/or the unit of time intervals/lags may be based on the maximum doppler shift or doppler spread or coherence time or the first correlation.

In some embodiments, the plurality of time intervals may be preconfigured or configured by the network device 120. Alternatively, the plurality of time intervals may be determined based on an interval between different tracking reference signal (TRS) sets or based on an interval between different TRS symbols within a TRS set or based on an interval between different TRS occasion within a TRS set or based on an interval between different slots within a TRS set. For example, the plurality of time intervals/lags may be preconfigured or configured by network device 120. Alternatively, the plurality of time intervals/lags may be determined based on the intervals between different TRS sets and/or between different TRS symbols within a TRS set or between different slots within a TRS set. In some embodiments, the plurality of correlation values may be preconfigured or configured by the network device 120.

In some embodiments, the TDCP report may correspond to a group of TRS sets. For example, there may be at least one TDCP reporting, each corresponding to one group of TRS sets. In some embodiments, the terminal device may be configured with at least one TDCP report, and each TDCP report may correspond to a group of TRS sets. For example, for multi-TRP.

In some embodiments, a user equipment (UE) capability may indicate at least one of: whether the terminal device supports the TDCP support, the number of correlations, the maximum number of correlations, the number of the plurality of time intervals, the maximum number of the plurality of time intervals, the maximum number of the plurality of doppler shifts, a processing delay, or the number of TDCP reports.

In some embodiments, a time interval corresponding to the TDCP report may be different from a timer interval of TRS. For example, as shown in FIG. 4A, the time intervals of TRS may be Xn, n=1,2 . . . . N. For example, N may be positive integer. For example, 1<=N<=8. The intervals of TDCP reporting may be Ym, for example, m=1,2 . . . . M. For example, M may be positive integer. For example, 1<=M<=16. The correlation value corresponding to time intervals Ym may be calculated/predicted by terminal device 110. In some embodiments, M may be larger than or no less than N. For example, M>=N. In some embodiments, the time intervals/lags Ym may be configured by network device 120 or determined based on at least one of Xn. For example, the time intervals Ym with m>N may be determined based on at least one value of Xn. In some embodiments, N may be different from M, or M>=N. For example, Y1=X1, Y2=X2, Y3=X2*P or X1*P. In this case, P may be a positive integer and may be configured by network device 120. In some embodiments, P may be determined based on the value of Xn or predetermined. In some embodiments, P may be a positive integer, and P may be at least one of {1, 2, 3, 4, 5, 6, 7, 8, 10, 12, 16, 20, 24, 30, 32, 40, 48, 60, 64, 80, 128, 256, 512}. For example, X1=1, X2=2, Y3=5. In this way, the TRS overhead may be reduced and more information of TDCP may be reported.

In some embodiments, the TDCP report may comprise a plurality of correlations on different time intervals. In some embodiments, the TDCP report may indicate an absolute value for each of the plurality of correlations. For example, TDCP reporting may comprise a plurality of correlations on different time intervals/lags, and for each one of the plurality of correlations, absolute value may be reported. In some embodiments, the value of a correlation may be at least one of V/10 or V/100 or V/20 or V/50 or V/1000. In some embodiments, V may be a positive integer or a non-negative integer. For example, 0<=V<=10. For another example, 0<=V<=100. For another example, 0<=V<=20. For another example, 0<=V<=50. For another example, 0<=V<=1000.

In some embodiments, at least one of: a value range, a bit size, or a step size for different fields for different correlations in the TDCP report may be different. For example, the step size may be at least one of {0.1, 0.2, 0.01, 0.02, 0.03, 0.04, 0.05}. In some embodiment, at least for the first correlation, there may be a state/value indicating the correlation is 1 or is >=a first threshold T1 (e.g. the first threshold may be 0.9 or 0.95 or 0.8).

In some embodiments, a value range for (n+1)-th correlation in the plurality of correlations may depend on a value for n-th correlation or a value for a first correlation in the plurality of correlations, where n is an integer. For example, if the first correlation is C1_1 or within a first range, the value range for the 2^{nd} correlation may be {R21_1, R22_1}, and if the first correlation is C1-2 or within a second range, the value range for the 2^{nd} correlation may be {R21_2, R22_2}. In some embodiments, R21_1 may be different from R21_2 and/or R22_1 may be different from R22_2. In some embodiments, the value of C1-1 and/or the value of C1-2 and/or the value of R21_1 and/or the value of R22_1 and/or the value of R21_2 and/or the value of R22_2 may be at least one of V/10 or V/100 or V/20 or V/50 or V/1000. In some embodiments, V may be a positive integer or a non-negative integer. For example, 0<=V<=10. For another example, 0<=V<=100. For another example, 0<=V<=20. For another example, 0<=V<=50. For another example, 0<=V<=1000.

In some embodiments, the bit size for the value range of 2^{nd} correlation may be fixed or independent of the value of first correlation, for example, B2 or ceil(log 2(maximum (N2_p))), where N2_p may be the number of possible values for the 2^{nd} correlation corresponding to one value of first correlation. In some embodiments, B2 may be a positive integer. For example, 1<=B2<=16. In some embodiments, N2_p may be a positive integer. For example, 1<=N2_p<=1000.

In some embodiments, the TDCP report may comprise a plurality of correlations on different time intervals. In this case, in some embodiments, the TDCP report may indicate an absolute value for a first correlation of the plurality of correlations and a differential value for other correlations in the plurality of correlations. For example, for the first correlation, absolute value for the first correlation, absolute value may be reported, and for other correlation(s) differential or fractional value may be reported.

In some embodiments, the value range and/or bit size and/or step size for different fields for different correlations (e.g. except the first correlation) may be different. For example, the step size may be at least one of {0.1, 0.2, 0.01, 0.02, 0.03, 0.04, 0.05}. In some embodiments, the fractional value may be at least one of {⅘, ¾, ⅔, ½, ⅓, ¼, ⅖, ⅗, ⅕}. In some embodiments, at least for the first correlation, there may be a state/value indicating the correlation is 1 or is >=a first threshold T1 (for example, the first threshold may be 0.9 or 0.95 or 0.85). In this way, more information of TDCP may be reported.

In some embodiments, the value range for (n+1)-th correlation may depend on the indicated value for the n-th correlation or for the first correlation. For example, if the first correlation is C1-1 or within a first range, the value range for the 2^{nd} correlation may be {R21_1, R22_1}, and if the first correlation is C1-2 or within a second range, the value range for the 2^{nd} correlation may be {R21_2, R22_2}. R21_1 may be different from R21_2 and/or R22_1 may be different from R22_2. In some embodiments, the value of C1-1 and/or the value of C1-2 and/or the value of R21_1 and/or the value of R22_1 and/or the value of R21_2 and/or the value of R22_2 may be at least one of V/10 or V/100 or V/20 or V/50 or V/1000. In some embodiments, V may be a positive integer or a non-negative integer. For example, 0<=V<=10. For another example, 0<=V<=100. For another example, 0<=V<=20. For another example, 0<=V<=50. For another example, 0<=V<=1000. In some embodiments, the bit size for the value range of 2^{nd} correlation may be fixed or independent of the value of first correlation, for example, B2 or ceil(log 2(maximum (N2_p))). N2_p may be the number of possible values for the 2nd correlation corresponding to one value of first correlation. In some embodiments, B2 may be a positive integer. For example, 1<=B2<=16. In some embodiments, N2_p may be a positive integer. For example, 1<=N2_p<=1000.

In some embodiments, the TDCP report may comprise a plurality of correlations on different time intervals and a doppler parameter. In some embodiments, the doppler parameter may comprise one or more: the maximum doppler shift, the doppler spread, or the coherence time or the speed of the terminal device. In some embodiments, at least one of: a value range, a bit size, or a step size for different fields for different correlations in the TDCP report depends on the doppler parameter. For example, the value range and/or bit size and/or step size and/or the time intervals/lags for different fields for different correlations may depend on the value of the doppler parameter. For example, the correlation no later than or after the coherence time may need to be reported. The correlation before the coherence time may not needed to be reported. The first correlation may correspond to the time interval/lag larger than the threshold time (e.g. coherence time). Starting from the first correlation, the plurality of correlations may be determined.

In some embodiments, the TDCP report may comprise the plurality of time intervals corresponding to the plurality of correlation values. Each time interval may correspond to a correlation value. For example, there may be a plurality of correlation values (e.g. Cn, Cn is a decimal, 0<Cn<1, and different from each other) or a plurality of correlation ranges (e.g. [0.9-1], [0.8-0.9], . . . ). The correlation value may be preconfigured/predefined or configured by the network device 120. The terminal device 110 may report a time interval/lag. The correlation on the time interval/lag may be same/similar as the correlation value Cn. In some embodiments, the number of correlation values/ranges and/or the number of time intervals/lags may be configured by the network device 120 or predefined or reported by the terminal device 110. In some embodiments, the value of time interval/lag may be Ln. Ln may be positive integer, for example, 1<=Ln<=128. In some embodiments, the unit of time intervals/lags may be configured by network device 120 or predefined or reported by the terminal device 110. For example, the unit may be a number of symbols/slots. In some embodiments, there may be no need of TRS transmission on the slots corresponding to the reported time intervals/lags.

In some embodiments, absolute/differential/fractional values may be applied, dependence of first value may be applied. In some embodiments, the TDCP report may comprise an absolute value for each time interval.

In some embodiments, a value range for (n+1)-th time interval in the plurality of time intervals may depend on a value for n-th time interval or a value for a first time interval in the plurality of time intervals, where n is an integer. In some embodiments, the TDCP report may indicate an absolute value for a first time interval of the plurality of time intervals and a differential value for other time intervals in the plurality of time intervals. For example, a value range for (n+1)-th time interval in the plurality of time intervals may depend on a value for n-th time interval or a value for a first time interval in the plurality of time intervals, where n is an integer.

In some embodiments, the TDCP report may comprise one or more of: an indication of whether there is an intra-set correlation, or an indication of intra-set or inter-set correlation. TDCP reporting may comprise a unit of time interval/lag (or an indication of whether there is intra-set correlation or not or an indication of intra-set or inter-set correlation) and a plurality of time intervals/lags corresponding to a plurality of correlation values. Each time interval/lag may correspond to a correlation value. In some embodiments, the unit of time interval/lag may be at least one of {1, 2, 3, 4, 5, 6, 8, 10, 12, 16, 20, 24, 40, 48, 60, 64, 80} slots. In some embodiments, at least one of: a value range, a bit size, or a step size for different fields for different time intervals depends on the unit of time interval.

In some embodiments, the TDCP report may comprise a plurality of doppler shifts. For example, the plurality of doppler shifts may be arranged in an increasing order of delays of multiple paths between the terminal device and the network device. In other words, TDCP reporting may comprise a plurality of doppler shifts (fd_1, fd_2, . . . fd_n), where the doppler shifts may be in increasing order of delays of multiple paths. In some embodiments, the value of at least one of (fd_1, fd_2, . . . fd_n) may be a positive integer. For example, 1<=fd_n<=15000. For another example, 1<=fd_n<=1500. For example, 1<=fd_n<=1000. In some embodiments, n may be a positive or a non-negative integer. For example, 0<=n<=20. Actually, in this case, it can be regarded as reporting a plurality of doppler bases with one spatial domain basis (single-port TRS) and reciprocity based frequency domain bases, while no reporting of amplitude and/or phase coefficients for the doppler bases.

In some embodiments, an n-th one of the plurality of doppler shifts may be a doppler shift of the channel response at the n-th path delay of the resource elements that carry the TRS signal configured for the measurement. For example, the first one of the plurality of doppler shifts may be a doppler shift of the channel response at the first path delay of the resource elements that carry the TRS signal configured for the measurement. For another example, doppler shift for the first path delay may be the doppler shift corresponding to the first detected path in time. For another example, doppler shift for the n-th path delay may be the doppler shift corresponding to the n-th detected path in time. In some embodiments, n may be a positive integer. For example, 1<=n<=20.

In some embodiments, the reference point for the doppler shift may be the antenna connector of the UE. For example, for frequency range 1. In some embodiments, doppler shift may be measured based on the combined signal from antenna elements corresponding to a given receiver branch. For example, for frequency range 2.

In some embodiments, if receiver diversity is in use by the UE for doppler shift measurements, the reported doppler shift value for the first and additional measurements may be provided for the same receiver branch(es) as applied for doppler shift measurements. For example, for frequency range 1 and 2.

In some embodiments, the value of a doppler shift or the value of a doppler spread or the value of a maximum doppler shift may be Fd Hz. In some embodiments, Fd may be a positive integer. For example, 1<=Fd<=15000. For another example, 1<=Fd<=1500. For example, 1<=Fd<=1000.

In some embodiments, the TDCP report may comprise an absolute value for each of the plurality of doppler shifts. In some other embodiments, the TDCP report may indicate an absolute value for a first doppler shift of the plurality of doppler shifts and (n+1) doppler shift is a differential value related to the first doppler shift or related to n-th doppler shift, where n is an integer. The differential value range may comprise both negative and positive values.

In some embodiments, the TDCP report may comprise a unit of doppler shift, and each of the plurality of doppler shifts may be based on the unit of doppler shift and a corresponding doppler shift field value in the TDCP report. In some embodiments, the TDCP reporting may also comprise a unit of doppler shift. In some embodiments, the unit of doppler shift may be Ud. In some embodiments, Ud may be a positive integer. For example, 1<=Ud<=15000. For another example, 1<=Ud<=1500. For another example, 1<=Ud<=100. For another example, Ud may be at least one of {1, 10, 100, 20, 40, 50, 60, 80, 200}. In some embodiments, each doppler shift is based on the unit of doppler shift and a corresponding doppler shift field value. In some embodiments, the doppler shift may be related to subcarrier spacing (SCS, i.e., u) or a ratio of SCS. For example, the unit of doppler shift may be a ratio of SCS. Alternatively, the unit of doppler shift may be related to u. In this way, more information of TDCP may be reported. In some embodiments, the ratio of SCS may be R. In some embodiments, R may be a positive integer. For example, 10<=R<=15000. In some embodiments, the value of ratio of SCS may be based on the value of SCS. For example, if a first SCS is larger than a second SCS, the first ratio of the first SCS may be larger than the second ratio of the second SCS.

In some embodiments, the terminal device may be configured with a value of SCS and/or a value of an indication for SCS (For example, μ). In some embodiments, μ may be a non-negative integer. For example, μ may be at least one of {0, 1, 2, 3, 4, 5, 6}. In some embodiments, μ=0 may correspond to SCS 15 KHz. In some embodiments, μ=1 may correspond to SCS 30 KHz. In some embodiments, μ=2 may correspond to SCS 60 KHz. In some embodiments, μ=3 may correspond to SCS 120 KHz. In some embodiments, μ=4 may correspond to SCS 240 KHz. In some embodiments, μ=5 may correspond to SCS 480 KHz. In some embodiments, μ=6 may correspond to SCS 960 KHz.

In some embodiments, the TDCP report may have a higher priority than a channel state information (CSI) report. For example, the TDCP reporting may have higher priority than other CSI reporting. In some embodiments, the other CSI reporting maybe except at leas one of: layer 1 reference signal received power (L1-RSRP), L1-sinal interference noise ratio (SINR) reporting, or a doppler based codebook reporting. For example, periodic/semi-persistent (P/SP) TDCP reporting may have higher priority than SP/aperiodic (AP) CSI reporting (for example, the CSI reporting may be at least one of: a precoding matrix indicator (PMI) reporting, a rank indicator (RI) reporting, a layer indicator (LI) reporting, a channel quality indicator (CQI) reporting and a CSI-RS resource indicator (CRI) reporting. For another example, the CSI reporting may not be L1-RSRP/L1-SINR and/or doppler based codebook/PMI reporting). For example, periodic TDCP reporting may have higher priority than periodic reporting of a first CSI and/or semi-persistent reporting of the first CSI and/or aperiodic reporting of the first CSI. For another example, semi-persistent TDCP reporting may have higher priority than periodic reporting of a first CSI and/or semi-persistent reporting of the first CSI and/or aperiodic reporting of the first CSI. For another example, aperiodic TDCP reporting may have higher priority than periodic reporting of a first CSI and/or semi-persistent reporting of the first CSI and/or aperiodic reporting of the first CSI. In some embodiments, the first CSI reporting may be at least one of: a precoding matrix indicator (PMI) reporting, a rank indicator (RI) reporting, a layer indicator (LI) reporting, a channel quality indicator (CQI) reporting and a CSI-RS resource indicator (CRI) reporting. In some embodiments, the CSI reporting may not be L1-RSRP/L1-SINR and/or doppler based codebook/PMI reporting. In some embodiments, TDCP may have lower priority than CRI and/or synchronization signal block (SSB) resource indicator (SSB-RI) and/or L1-RSRP and/or L1-SINR reporting in same or across different time domain behavior. In some other embodiments, TDCP may have lower priority than doppler based codebook/PMI reporting in same or across different time domain behavior. In some embodiments, the time domain behavior may comprise at least one of: aperiodic, semi-persistent and periodic. In this way, TDCP may be reported more efficiently.

In some embodiments, the TDCP may comprise at least one correlation or indication that is associated with a CSI reference signal (CSI-RS) or CSI configuration. In other words, TDCP reporting may be at least one correlation or an indication. In this cae, the indication may be a suggestion for CSI-RS or CSI configuration. In some embodiments, for correlation, the value range may be {0-1}. For example, the value range for correlation may be at least one of {0, 0.1, 0.2, 0.3, 0.4, 0.5, 0.6, 0.7, 0.8, 0.9, 1} Alternatively, for the indication, the value may be {⅛, ¼, ½, 1, 2, 4, 8, 16, 32, 64, 128}. In some embodiments, the indication may be combined with CSI Reference Signal Resource Indicator (CRI) for a corresponding CSI-RS. For example, the indication value may be the suggestion for the periodicity coefficient of CSI-RS or CSI reporting. In some embodiments, for TDCP, there may be only one bit, for example, {0,1}. Only as an example, “0” may indicate current configuration is OK, and “1” may indicate CSI-RS or CSI reporting periodicity may be updated/reduced.

In some embodiments, a first processing time for the TDCP report may comprise at least one of: a total number of CSI-RS resources in multiple TRS sets for the TDCP report, a total number of time intervals for the TDCP report, a number of CSI-RS resources in a TRS set for the TDCP report multiplying a value, where the value is configured by the network device or preconfigured. For example, regarding TDCP processing, for a CSI report with CSI-ReportConfig with higher layer parameter reportQuantity set to ‘tdcp’ (or ‘cri-tdcp’), O_{CPU}μ=Y, where Y may be at least one of: the total number of CSI-RS resources in the multiple TRS sets; the total number of time intervals/lags for TDCP reporting; the number of CSI-RS resources in the TRS set (e.g. in case of only one TRS set for TDCP reporting) multiplies a first value, wherein the first value may be configured by network device or predefined (e.g. the number of occasions of TRS for TDCP reporting).

In some embodiments, a second processing time for coherent joint transmission (CJT) may comprise a combination of a number of central processing units (CPUs) occupied by a set of CSI-RS resources for CJT and a second value, where the second value is 0 or a number of single-transmission reception point (TRP) hypothesis. For example, for CSI for CJT processing, O_{CPU}μ=Y+M, where Y may be the number of CPUs occupied by the set of CSI-RS resources for CJT (subject to at least one of UE capabilities]) and M may be 0 or number of single-TRP hypothesis.

In some embodiments, a third processing time for a velocity processing may comprise a combination of a number of CPUs occupied by a set of CSI-RS resource for the velocity and a third value. Alternatively, the third processing time may comprise a combination of a number of CSI-RS occasions in a CSI-RS set for the velocity and the third value, and where the third value is a predetermined number. For example, for CSI for high/medium velocities processing, O_{CPU}μ=Y+M, where Y may be the number of CPUs occupied by the sets of CSI-RS resources for high/medium velocities (or by the number of CSI-RS occasions in a CSI-RS set for high/medium velocities) subject to at least one of UE capabilities and M may be 0 or 1. In this way, TDCP may be processed properly.

In some embodiments, there may be a UE capability indicating whether the UE supports speed information reporting. For example, upon request from the network device. In some embodiments, if the terminal device supports speed information reporting, the TDCP reporting may comprise a first set of parameters, and if the terminal device does not support speed information reporting, the TDCP reporting may comprise a second set of parameters. In some embodiments, the second set of parameters may comprise the first set of parameters and at least one of: a maximum doppler shift, doppler spread, coherence time and a speed value of the terminal device.

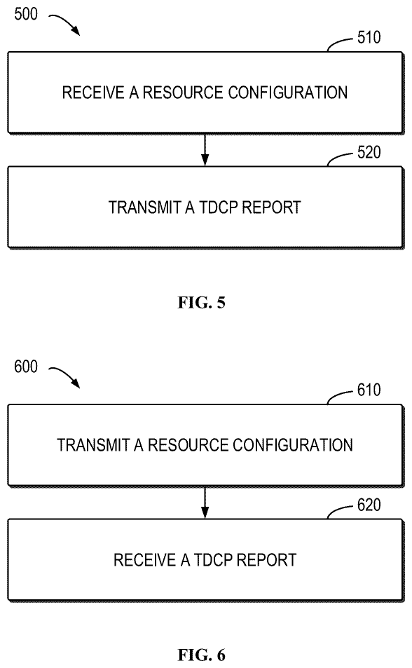

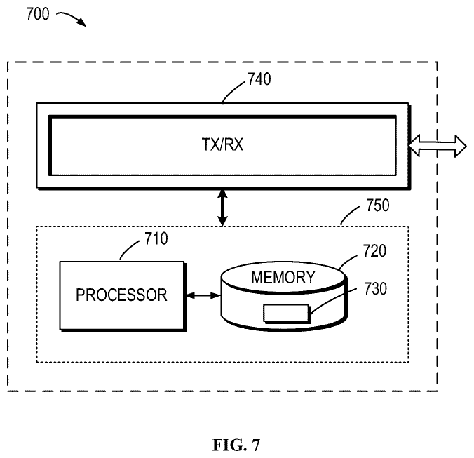

FIG. 6 shows a flowchart of an example method 600 in accordance with an embodiment of the present disclosure. The method 600 can be implemented at any suitable terminal devices. Only for the purpose of illustrations, the method 600 can be implemented at a network device 120 as shown in FIG. 1.

In some embodiments, at block 610, the network device 120 may transmit a resource configuration to the terminal device 110. In some embodiments, the terminal device 110 may be configured with at least one set of CSI-RS for tracking TRS and the set of CSI-RS for tracking may be associated with a TDCP reporting or may be applied for reporting of one TDCP. In this case, the number of sets may be N, N is positive integer, for example, 1<=N<=8. Each set may comprise two CSI-RS resources in one slot or four CSI-RS resources in two consecutive slots with two CSI-RS resources in each slot. The time interval between two CSI-RS resource sets (for example, between the n-th resource set and (n+1)-th resource set) may be Xn slots or symbols. In some embodiments, n may be positive or non-negative integer. For example, 1<=n<=N−1. In some embodiments, Xn may be positive integer. For example, 1<=Xn<=8. For another example, 1<=Xn<=128. For another example, 1<=Xn<=1792. In some embodiments, Xn may be same or different for different values of n. In some embodiments, the time interval between the (n+1)-th resource set and the first resource set may be

$${\sum }_{i = 1}^{n} X i$$

slots. In some embodiments, the time interval between the n-th resource set and the m-th resource set may be Zn,m slots or symbols. In some embodiments, n may be positive or non-negative integer. In some embodiments, m may be positive or non-negative integer. In some embodiments, 1<=n<=N−1. In some embodiments, 1<=m<=N. In some embodiments, n<m<=N. In some embodiments, Zn,m may be positive integer. For example, 1<=Zn,m<=8. For another example, 1<=Zn,m<=128. For another example, 1<=Zn,m<=1792. In some embodiments, the time interval between the n-th resource set and the m-th resource set may be

$${\sum }_{i = n}^{m - 1} X i$$

slots.

In some embodiments, the network device 120 may transmit the at least one CSI-RS for tracking resource set to the terminal device 110. In some embodiments, the network device 120 may transmit the at least one set of CSI-RS for tracking to the terminal device 110.

Alternatively, in some embodiments, the time interval between the n-th TRS resource set and the first resource set may be Wn slots or symbols. For example, 2<=n<=N. In some embodiments, Wn may be positive integer. For example, 1<=Wn<=8. For another example, 1<=Wn<=128. For another example, 1<=Wn<=1792.

In some embodiments, the terminal device 110 may be configured with one set of CSI-RS resources for tracking reference signal and the periodicity of the CSI-RS resources. In some embodiments, the periodicity values of TRS may be one of {10,20,40,80} ms or may be one of {1, 2, 3, 4, 5, 6, 8, 10, 12, 16, 20, 32, 40, 64, 80, 128, 160, 256, 320, 640, 1280, 2560, 5120} slots or may be one of {1, 2, 3, 4, 5, 6, 8, 12, 16, 24, 32, 48, 64} ms. In some embodiments, each set comprising two CSI-RS resources in one slot may be sufficient for TDCP reporting. And for configuration 1, the first resource set may comprise four CSI-RS resources in two consecutive slots (for fine time/frequency tracking). In this way, resources can be saved.

In some embodiments, the terminal device 110 may assume the antenna port with the same port index of the configured NZP CSI-RS resources in the multiple TRS sets is the same. In some embodiments, multiple TRS sets (for example, for one TDCP reporting) may have same power. For example, same powerControlOffset and powerControlOffsetSS given by NZP-CSI-RS-Resource value may be across all resources across all sets for one TDCP reporting.

In some embodiments, the QCL information (typeC and/or typeD source RS/SSB) for periodic NZP CSI-RS resources may be same applies to all resources across the multiple TRS sets for one TDCP reporting. Alternatively, or in addition, bandwidth and subcarrier location may be same for the CSI-RS resources across the multiple TRS sets for one TDCP reporting.

In some embodiments, no BWP switching may be expected at least within a burst of the multiple TRS sets for one TDCP reporting. Otherwise, the TDCP reporting may be dropped or not updated.

In some embodiments, the periodicity of the multiple TRS sets for one TDCP reporting may be different. For example, a first TRS set may have a first periodicity, and the other TRS sets may have a second periodicity. In some embodiments, the first periodicity may be no larger than the second periodicity. In some embodiments, the TDCP reporting periodicity may be same with the second or no less than the second periodicity. In some other embodiments, periodicity or interval for TDCP reporting may be no less than or larger than or a multiple of periodicity of TRS.

In some embodiments, TRS for TDCP may not applied for source RS for other RS/channels. In some embodiments, the first TRS resource set may can be applied. In some embodiments, the TDCP reporting may be per band or across CCs, for example, at least across CCs sharing a common unified TCI.

In some embodiments, the terminal device may be capable of performing TDCP measurement based on the configured at least one TRS resource or resource set for TDCP reporting/computation/calculation/measurement. In some embodiments, the physical layer of the terminal device may be capable of reporting TDCP measured over the measurement period.

At block 620, the network device 120 receives a TDCP report from the terminal device 110. In some embodiments, the TDCP report may comprise a set of parameters. In some embodiments, the set of parameters may comprise one or more of: a maximum doppler shift, a plurality of doppler shifts, a number of the plurality of doppler shifts, a doppler spread, a coherence time, a speed of the terminal device, a plurality of correlations on a plurality of time intervals, a plurality of indications of a plurality of time intervals, a number of the plurality of correlations, a number of the plurality of indications, a unit of time interval, a time interval unit, a unit of doppler shift, a unit of frequency, a frequency unit and a number of the plurality of time intervals.

In some embodiments, the number of the plurality of correlations may be at least one of {1,2,3,4,5,6,7,8,9,10}. In some embodiments, the number of the plurality of indications may be at least one of {1,2,3,4,5,6,7,8,9,10}. In some embodiments, the number of the plurality of time intervals may be at least one of {1,2,3,4,5,6,7,8,9,10}.

In some embodiments, the set of parameters may comprise one or more of: a maximum doppler shift, a doppler spread, a coherence time, a speed of the terminal device. In some embodiments, the set of parameters may comprise at least one correlation information on a plurality of time intervals among resources or resource sets for the TDCP report or a plurality of correlations on the plurality of time intervals. In some embodiments, the TDCP report may comprise at least one indication of the plurality of time intervals or a plurality of indications of the plurality of time intervals. Alternatively, in some embodiments, the plurality of time intervals among resources or resource sets for the TDCP report may be configured by the network device 120. In some embodiments, the TDCP report may comprise one or more of: an indication of the plurality of time intervals, a plurality of correlations on the plurality of time intervals, or a number of the plurality of correlations.

In some embodiments, the set of parameters may comprise at least one indication of the plurality of time intervals corresponding to a plurality of correlation values. In some embodiments, each time interval may correspond to a correlation value. For example, there may be a correlation value (e.g. C1, C1 is a decimal, 0<C1<1). In some embodiments, the correlation value may be preconfigured/predefined or configured by network device 120. In this case, in some embodiments, the terminal device 110 may report a time interval corresponding to the correlation value C1. For example, the correlation on the time interval may be same/similar as or close to the correlation value C1. In some embodiments, the TDCP report may indicate the number of the at least one indication and/or the number of the plurality of time intervals. In some embodiments, the set of parameters may comprise a unit of time interval. Alternatively, in some embodiments, the unit of time interval may be configured by the network device 120. For example, the value of the unit of time interval may be based on the value of subcarrier spacing. In some embodiments, the value of subcarrier spacing may be at least one of {15, 30, 60, 120, 240, 480, 960, 1920} KHz or at least one of {15000, 30000, 60000, 120000, 240000, 480000, 960000, 1920000} Hz.

In some embodiments, at least one of a value range, a step size or a number of bits for a first parameter from the set of parameters may be based on at least one of a value of or a value range for a second parameter from the set of parameters.

In some embodiments, a second correlation value or a range of the second correlation value or a step size of a range of the second correlation value on a second time interval may be based on a first correlation value on a first time interval. For example, a second correlation on a second time interval/lag may be based on a first correlation on a first time interval/lag (e.g. differential or fractional related to the first correlation).

In some embodiments, the plurality of time intervals or the unit of time interval may be based on one of: the maximum doppler shift, the doppler spread, the coherence time, or a first correlation. For example, the plurality of time intervals/lags and/or the unit of time intervals/lags may be based on the maximum doppler shift or doppler spread or coherence time or the first correlation.

In some embodiments, the plurality of time intervals may be preconfigured or configured by the network device 120. Alternatively, the plurality of time intervals may be determined based on an interval between different tracking reference signal (TRS) sets or based on an interval between different TRS symbols within a TRS set or based on an interval between different TRS occasion within a TRS set or based on an interval between different slots within a TRS set. For example, the plurality of time intervals/lags may be preconfigured or configured by network device 120. Alternatively, the plurality of time intervals/lags may be determined based on the intervals between different TRS sets and/or between different TRS symbols within a TRS set or between different slots within a TRS set. In some embodiments, the plurality of correlation values may be preconfigured or configured by the network device 120.

In some embodiments, the TDCP report may correspond to a group of TRS sets. For example, there may be at least one TDCP reporting, each corresponding to one group of TRS sets. In some embodiments, the terminal device may be configured with at least one TDCP report, and each TDCP report may correspond to a group of TRS sets. For example, for multi-TRP.

In some embodiments, a user equipment (UE) capability may indicate at least one of: whether the terminal device supports the TDCP support, the number of correlations, the maximum number of correlations, the number of the plurality of time intervals, the maximum number of the plurality of time intervals, the maximum number of the plurality of doppler shifts, a processing delay, or the number of TDCP reports.

In some embodiments, a time interval corresponding to the TDCP report may be different from a timer interval of TRS. For example, as shown in FIG. 4A, the time intervals of TRS may be Xn, n=1,2 . . . . N. For example, N may be positive integer. For example, 1<=N<=8. The intervals of TDCP reporting may be Ym, for example, m=1,2 . . . . M. For example, M may be positive integer. For example, 1<=M<=16. The correlation value corresponding to time intervals Ym may be calculated/predicted by terminal device 110. In some embodiments, M may be larger than or no less than N. For example, M>=N. In some embodiments, the time intervals/lags Ym may be configured by network device 120 or determined based on at least one of Xn. For example, the time intervals Ym with m>N may be determined based on at least one value of Xn. In some embodiments, N may be different from M, or M>=N. For example, Y1=X1, Y2=X2, Y3=X2*P or X1*P. In this case, P may be a positive integer and may be configured by network device 120. In some embodiments, P may be determined based on the value of Xn or predetermined. In some embodiments, P may be a positive integer, and P may be at least one of {1, 2, 3, 4, 5, 6, 7, 8, 10, 12, 16, 20, 24, 30, 32, 40, 48, 60, 64, 80, 128, 256, 512}. For example, X1=1, X2=2, Y3=5. In this way, the TRS overhead may be reduced and more information of TDCP may be reported.

In some embodiments, the TDCP report may comprise a plurality of correlations on different time intervals. In some embodiments, the TDCP report may indicate an absolute value for each of the plurality of correlations. For example, TDCP reporting may comprise a plurality of correlations on different time intervals/lags, and for each one of the plurality of correlations, absolute value may be reported. In some embodiments, the value of a correlation may be at least one of V/10 or V/100 or V/20 or V/50 or V/1000. In some embodiments, V may be a positive integer or a non-negative integer. For example, 0<=V<=10. For another example, 0<=V<=100. For another example, 0<=V<=20. For another example, 0<=V<=50. For another example, 0<=V<=1000.

In some embodiments, at least one of: a value range, a bit size, or a step size for different fields for different correlations in the TDCP report may be different. For example, the step size may be at least one of {0.1, 0.2, 0.01, 0.02, 0.03, 0.04, 0.05}. In some embodiment, at least for the first correlation, there may be a state/value indicating the correlation is 1 or is >=a first threshold T1 (e.g. the first threshold may be 0.9 or 0.95 or 0.8).

In some embodiments, a value range for (n+1)-th correlation in the plurality of correlations may depend on a value for n-th correlation or a value for a first correlation in the plurality of correlations, where n is an integer. For example, if the first correlation is C1_1 or within a first range, the value range for the 2^{nd} correlation may be {R21_1, R22_1}, and if the first correlation is C1-2 or within a second range, the value range for the 2^{nd} correlation may be {R21_2, R22_2}. In some embodiments, R21_1 may be different from R21_2 and/or R22_1 may be different from R22_2. In some embodiments, the value of C1_1 and/or the value of C1-2 and/or the value of R21_1 and/or the value of R22_1 and/or the value of R21_2 and/or the value of R22_2 may be at least one of V/10 or V/100 or V/20 or V/50 or V/1000. In some embodiments, V may be a positive integer or a non-negative integer. For example, 0<=V<=10. For another example, 0<=V<=100. For another example, 0<=V<=20. For another example, 0<=V<=50. For another example, 0<=V<=1000.

In some embodiments, the bit size for the value range of 2^{nd} correlation may be fixed or independent of the value of first correlation, for example, B2 or ceil(log 2(maximum (N2_p))), where N2_p may be the number of possible values for the 2^{nd} correlation corresponding to one value of first correlation. In some embodiments, B2 may be a positive integer. For example, 1<=B2<=16. In some embodiments, N2_p may be a positive integer. For example, 1<=N2_p<=1000.

In some embodiments, the TDCP report may comprise a plurality of correlations on different time intervals. In this case, in some embodiments, the TDCP report may indicate an absolute value for a first correlation of the plurality of correlations and a differential value for other correlations in the plurality of correlations. For example, for the first correlation, absolute value for the first correlation, absolute value may be reported, and for other correlation(s) differential or fractional value may be reported.

In some embodiments, the value range and/or bit size and/or step size for different fields for different correlations (e.g. except the first correlation) may be different. For example, the step size may be at least one of {0.1, 0.2, 0.01, 0.02, 0.03, 0.04, 0.05}. In some embodiments, the fractional value may be at least one of {⅘, ¾, ⅔, ½, ⅓, ¼, ⅖, ⅗, ⅕}. In some embodiments, at least for the first correlation, there may be a state/value indicating the correlation is 1 or is >=a first threshold T1 (for example, the first threshold may be 0.9 or 0.95 or 0.85). In this way, more information of TDCP may be reported.

In some embodiments, the value range for (n+1)-th correlation may depend on the indicated value for the n-th correlation or for the first correlation. For example, if the first correlation is C1-1 or within a first range, the value range for the 2^{nd} correlation may be {R21_1, R22_1}, and if the first correlation is C1-2 or within a second range, the value range for the 2^{nd} correlation may be {R21_2, R22_2}. R21_1 may be different from R21_2 and/or R22_1 may be different from R22_2. In some embodiments, the value of C1-1 and/or the value of C1-2 and/or the value of R21_1 and/or the value of R22_1 and/or the value of R21_2 and/or the value of R22_2 may be at least one of V/10 or V/100 or V/20 or V/50 or V/1000. In some embodiments, V may be a positive integer or a non-negative integer. For example, 0<=V<=10. For another example, 0<=V<=100. For another example, 0<=V<=20. For another example, 0<=V<=50. For another example, 0<=V<=1000. In some embodiments, the bit size for the value range of 2^{nd} correlation may be fixed or independent of the value of first correlation, for example, B2 or ceil(log 2(maximum (N2_p))). N2_p may be the number of possible values for the 2nd correlation corresponding to one value of first correlation. In some embodiments, B2 may be a positive integer. For example, 1<=B2<=16. In some embodiments, N2_p may be a positive integer. For example, 1<=N2_p<=1000.

In some embodiments, the TDCP report may comprise a plurality of correlations on different time intervals and a doppler parameter. In some embodiments, the doppler parameter may comprise one or more: the maximum doppler shift, the doppler spread, or the coherence time or the speed of the terminal device. In some embodiments, at least one of: a value range, a bit size, or a step size for different fields for different correlations in the TDCP report depends on the doppler parameter. For example, the value range and/or bit size and/or step size and/or the time intervals/lags for different fields for different correlations may depend on the value of the doppler parameter. For example, the correlation no later than or after the coherence time may need to be reported. The correlation before the coherence time may not needed to be reported. The first correlation may correspond to the time interval/lag larger than the threshold time (e.g. coherence time). Starting from the first correlation, the plurality of correlations may be determined.

In some embodiments, the TDCP report may comprise the plurality of time intervals corresponding to the plurality of correlation values. Each time interval may correspond to a correlation value. For example, there may be a plurality of correlation values (e.g. Cn, Cn is a decimal, 0<Cn<1, and different from each other) or a plurality of correlation ranges (e.g. [0.9-1], [0.8-0.9], . . . ). The correlation value may be preconfigured/predefined or configured by the network device 120. The terminal device 110 may report a time interval/lag. The correlation on the time interval/lag may be same/similar as the correlation value Cn. In some embodiments, the number of correlation values/ranges and/or the number of time intervals/lags may be configured by the network device 120 or predefined or reported by the terminal device 110. In some embodiments, the value of time interval/lag may be Ln. Ln may be positive integer, for example, 1<=Ln<=128. In some embodiments, the unit of time intervals/lags may be configured by network device 120 or predefined or reported by the terminal device 110. For example, the unit may be a number of symbols/slots. In some embodiments, there may be no need of TRS transmission on the slots corresponding to the reported time intervals/lags.

In some embodiments, absolute/differential/fractional values may be applied, dependence of first value may be applied. In some embodiments, the TDCP report may comprise an absolute value for each time interval.

In some embodiments, a value range for (n+1)-th time interval in the plurality of time intervals may depend on a value for n-th time interval or a value for a first time interval in the plurality of time intervals, where n is an integer. In some embodiments, the TDCP report may indicate an absolute value for a first time interval of the plurality of time intervals and a differential value for other time intervals in the plurality of time intervals. For example, a value range for (n+1)-th time interval in the plurality of time intervals may depend on a value for n-th time interval or a value for a first time interval in the plurality of time intervals, where n is an integer.

In some embodiments, the TDCP report may comprise one or more of: an indication of whether there is an intra-set correlation, or an indication of intra-set or inter-set correlation. TDCP reporting may comprise a unit of time interval/lag (or an indication of whether there is intra-set correlation or not or an indication of intra-set or inter-set correlation) and a plurality of time intervals/lags corresponding to a plurality of correlation values. Each time interval/lag may correspond to a correlation value. In some embodiments, the unit of time interval/lag may be at least one of {1, 2, 3, 4, 5, 6, 8, 10, 12, 16, 20, 24, 40, 48, 60, 64, 80} slots. In some embodiments, at least one of: a value range, a bit size, or a step size for different fields for different time intervals depends on the unit of time interval.

In some embodiments, the TDCP report may comprise a plurality of doppler shifts. For example, the plurality of doppler shifts may be arranged in an increasing order of delays of multiple paths between the terminal device and the network device. In other words, TDCP reporting may comprise a plurality of doppler shifts (fd_1, fd_2, . . . fd_n), where the doppler shifts may be in increasing order of delays of multiple paths. In some embodiments, the value of at least one of (fd_1, fd_2, . . . fd_n) may be a positive integer. For example, 1<=fd_n<=15000. For another example, 1<=fd_n<=1500. For example, 1<=fd_n<=1000. In some embodiments, n may be a positive or a non-negative integer. For example, 0<=n<=20. Actually, in this case, it can be regarded as reporting a plurality of doppler bases with one spatial domain basis (single-port TRS) and reciprocity based frequency domain bases, while no reporting of amplitude and/or phase coefficients for the doppler bases.

In some embodiments, an n-th one of the plurality of doppler shifts may be a doppler shift of the channel response at the n-th path delay of the resource elements that carry the TRS signal configured for the measurement. For example, the first one of the plurality of doppler shifts may be a doppler shift of the channel response at the first path delay of the resource elements that carry the TRS signal configured for the measurement. For another example, doppler shift for the first path delay may be the doppler shift corresponding to the first detected path in time. For another example, doppler shift for the n-th path delay may be the doppler shift corresponding to the n-th detected path in time. In some embodiments, n may be a positive integer. For example, 1<=n<=20.

In some embodiments, the reference point for the doppler shift may be the antenna connector of the UE. For example, for frequency range 1. In some embodiments, doppler shift may be measured based on the combined signal from antenna elements corresponding to a given receiver branch. For example, for frequency range 2.

In some embodiments, if receiver diversity is in use by the UE for doppler shift measurements, the reported doppler shift value for the first and additional measurements may be provided for the same receiver branch(es) as applied for doppler shift measurements. For example, for frequency range 1 and 2.

In some embodiments, the value of a doppler shift or the value of a doppler spread or the value of a maximum doppler shift may be Fd Hz. In some embodiments, Fd may be a positive integer. For example, 1<=Fd<=15000. For another example, 1<=Fd<=1500. For example, 1<=Fd<=1000.

In some embodiments, the TDCP report may comprise an absolute value for each of the plurality of doppler shifts. In some other embodiments, the TDCP report may indicate an absolute value for a first doppler shift of the plurality of doppler shifts and (n+1) doppler shift is a differential value related to the first doppler shift or related to n-th doppler shift, where n is an integer. The differential value range may comprise both negative and positive values.

In some embodiments, the TDCP report may comprise a unit of doppler shift, and each of the plurality of doppler shifts may be based on the unit of doppler shift and a corresponding doppler shift field value in the TDCP report. In some embodiments, the TDCP reporting may also comprise a unit of doppler shift. In some embodiments, the unit of doppler shift may be Ud. In some embodiments, Ud may be a positive integer. For example, 1<=Ud<=15000. For another example, 1<=Ud<=1500. For another example, 1<=Ud<=100. For another example, Ud may be at least one of {1, 10, 100, 20, 40, 50, 60, 80, 200}. In some embodiments, each doppler shift is based on the unit of doppler shift and a corresponding doppler shift field value. In some embodiments, the doppler shift may be related to subcarrier spacing (SCS, i.e., u) or a ratio of SCS. For example, the unit of doppler shift may be a ratio of SCS. Alternatively, the unit of doppler shift may be related to u. In this way, more information of TDCP may be reported. In some embodiments, the ratio of SCS may be R. In some embodiments, R may be a positive integer. For example, 10<=R<=15000. In some embodiments, the value of ratio of SCS may be based on the value of SCS. For example, if a first SCS is larger than a second SCS, the first ratio of the first SCS may be larger than the second ratio of the second SCS.

In some embodiments, the terminal device may be configured with a value of SCS and/or a value of an indication for SCS (For example, u). In some embodiments, μ may be a non-negative integer. For example, μ may be at least one of {0, 1, 2, 3, 4, 5, 6}. In some embodiments, μ=0 may correspond to SCS 15 KHz. In some embodiments, μ=1 may correspond to SCS 30 KHz. In some embodiments, μ=2 may correspond to SCS 60 KHz. In some embodiments, μ=3 may correspond to SCS 120 KHz. In some embodiments, μ=4 may correspond to SCS 240 KHz. In some embodiments, μ=5 may correspond to SCS 480 KHz. In some embodiments, μ=6 may correspond to SCS 960 KHz.

In some embodiments, the TDCP report may have a higher priority than a channel state information (CSI) report. For example, the TDCP reporting may have higher priority than other CSI reporting. In some embodiments, the other CSI reporting maybe except at leas one of: layer 1 reference signal received power (L1-RSRP), L1-sinal interference noise ratio (SINR) reporting, or a doppler based codebook reporting. For example, periodic/semi-persistent (P/SP) TDCP reporting may have higher priority than SP/aperiodic (AP) CSI reporting (for example, the CSI reporting may be at least one of: a precoding matrix indicator (PMI) reporting, a rank indicator (RI) reporting, a layer indicator (LI) reporting, a channel quality indicator (CQI) reporting and a CSI-RS resource indicator (CRI) reporting. For another example, the CSI reporting may not be L1-RSRP/L1-SINR and/or doppler based codebook/PMI reporting). For example, periodic TDCP reporting may have higher priority than periodic reporting of a first CSI and/or semi-persistent reporting of the first CSI and/or aperiodic reporting of the first CSI. For another example, semi-persistent TDCP reporting may have higher priority than periodic reporting of a first CSI and/or semi-persistent reporting of the first CSI and/or aperiodic reporting of the first CSI. For another example, aperiodic TDCP reporting may have higher priority than periodic reporting of a first CSI and/or semi-persistent reporting of the first CSI and/or aperiodic reporting of the first CSI. In some embodiments, the first CSI reporting may be at least one of: a precoding matrix indicator (PMI) reporting, a rank indicator (RI) reporting, a layer indicator (LI) reporting, a channel quality indicator (CQI) reporting and a CSI-RS resource indicator (CRI) reporting. In some embodiments, the CSI reporting may not be L1-RSRP/L1-SINR and/or doppler based codebook/PMI reporting. In some embodiments, TDCP may have lower priority than CRI and/or synchronization signal block (SSB) resource indicator (SSB-RI) and/or L1-RSRP and/or L1-SINR reporting in same or across different time domain behavior. In some other embodiments, TDCP may have lower priority than doppler based codebook/PMI reporting in same or across different time domain behavior. In some embodiments, the time domain behavior may comprise at least one of: aperiodic, semi-persistent and periodic. In this way, TDCP may be reported more efficiently.

In some embodiments, the TDCP may comprise at least one correlation or indication that is associated with a CSI reference signal (CSI-RS) or CSI configuration. In other words, TDCP reporting may be at least one correlation or an indication. In this cae, the indication may be a suggestion for CSI-RS or CSI configuration. In some embodiments, for correlation, the value range may be {0-1}. For example, the value range for correlation may be at least one of {0, 0.1, 0.2, 0.3, 0.4, 0.5, 0.6, 0.7, 0.8, 0.9, 1} Alternatively, for the indication, the value may be {⅛, ¼, ½, 1, 2, 4, 8, 16, 32, 64, 128}. In some embodiments, the indication may be combined with CSI Reference Signal Resource Indicator (CRI) for a corresponding CSI-RS. For example, the indication value may be the suggestion for the periodicity coefficient of CSI-RS or CSI reporting. In some embodiments, for TDCP, there may be only one bit, for example, {0, 1}. Only as an example, “0” may indicate current configuration is OK, and “1” may indicate CSI-RS or CSI reporting periodicity may be updated/reduced.

In some embodiments, a first processing time for the TDCP report may comprise at least one of: a total number of CSI-RS resources in multiple TRS sets for the TDCP report, a total number of time intervals for the TDCP report, a number of CSI-RS resources in a TRS set for the TDCP report multiplying a value, where the value is configured by the network device or preconfigured. For example, regarding TDCP processing, for a CSI report with CSI-ReportConfig with higher layer parameter reportQuantity set to ‘tdcp’ (or ‘cri-tdcp’), O_{CPU}μ=Y, where Y may be at least one of: the total number of CSI-RS resources in the multiple TRS sets; the total number of time intervals/lags for TDCP reporting; the number of CSI-RS resources in the TRS set (e.g. in case of only one TRS set for TDCP reporting) multiplies a first value, wherein the first value may be configured by network device or predefined (e.g. the number of occasions of TRS for TDCP reporting).

In some embodiments, a second processing time for coherent joint transmission (CJT) may comprise a combination of a number of central processing units (CPUs) occupied by a set of CSI-RS resources for CJT and a second value, where the second value is 0 or a number of single-transmission reception point (TRP) hypothesis. For example, for CSI for CJT processing, O_{CPU}μ=Y+M, where Y may be the number of CPUs occupied by the set of CSI-RS resources for CJT (subject to at least one of UE capabilities]) and M may be 0 or number of single-TRP hypothesis.

In some embodiments, a third processing time for a velocity processing may comprise a combination of a number of CPUs occupied by a set of CSI-RS resource for the velocity and a third value. Alternatively, the third processing time may comprise a combination of a number of CSI-RS occasions in a CSI-RS set for the velocity and the third value, and where the third value is a predetermined number. For example, for CSI for high/medium velocities processing, O_{CPU}μ=Y+M, where Y may be the number of CPUs occupied by the sets of CSI-RS resources for high/medium velocities (or by the number of CSI-RS occasions in a CSI-RS set for high/medium velocities) subject to at least one of UE capabilities and M may be 0 or 1. In this way, TDCP may be processed properly.

In some embodiments, there may be a UE capability indicating whether the UE supports speed information reporting. For example, upon request from the network device. In some embodiments, if the terminal device supports speed information reporting, the TDCP reporting may comprise a first set of parameters, and if the terminal device does not support speed information reporting, the TDCP reporting may comprise a second set of parameters. In some embodiments, the second set of parameters may comprise the first set of parameters and at least one of: a maximum doppler shift, doppler spread, coherence time and a speed value of the terminal device.

FIG. 7 is a simplified block diagram of a device 700 that is suitable for implementing embodiments of the present disclosure. The device 700 can be considered as a further example implementation of the terminal device 110 or the network device 120 as shown in FIG. 1. Accordingly, the device 700 can be implemented at or as at least a part of the terminal device 110 or the network device 120.

As shown, the device 700 includes a processor 710, a memory 720 coupled to the processor 710, a suitable transmitter (TX)/receiver (RX) 740 coupled to the processor 710, and a communication interface coupled to the TX/RX 740. The memory 710 stores at least a part of a program 730. The TX/RX 740 is for bidirectional communications. The TX/RX 740 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 730 is assumed to include program instructions that, when executed by the associated processor 710, enable the device 700 to operate in accordance with the embodiments of the present disclosure, as discussed herein with reference to FIGS. 1 to 6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

In some embodiments, a terminal device comprises a circuitry configured to perform: transmitting, to a network device, a time domain channel properties (TDCP) report comprising a set of parameters, wherein the set of parameters comprises at least one of: a maximum doppler shift, a doppler spread, a coherence time, a speed of the terminal device, correlation information on a plurality of time intervals among resources or resource sets for the TDCP report, an indication of the plurality of time intervals corresponding to a plurality of correlation values, or a unit of time interval, and wherein at least one of a value range, a step size or a number of bits for a first parameter from the set of parameters is based on at least one of a value of or a value range for a second parameter from the set of parameters.

In some embodiments, the correlation information on the plurality of time intervals comprises at least one of: an indication of the plurality of time intervals, a plurality of correlations on the plurality of time intervals, or a number of the plurality of correlations.

In some embodiments, a second correlation value or a range of the second correlation value or a step size of a range of the second correlation value on a second time interval is based on a first correlation value on a first time interval.

In some embodiments, at least one of: the plurality of time intervals or the unit of time interval is based on one of: the maximum doppler shift, the doppler spread, the coherence time, or a first correlation.

In some embodiments, the plurality of time intervals are preconfigured or configured by the network device, or wherein the plurality of time intervals are determined based on an interval between different tracking reference signal (TRS) sets or based on an interval between different TRS symbols within a TRS set.

In some embodiments, the plurality of correlation values are preconfigured or configured by the network device.

In some embodiments, the TDCP report corresponds to a group of TRS sets.

In some embodiments, a user equipment (UE) capability indicates at least one of: whether the terminal device supports the TDCP support, the number of correlations, the maximum number of time intervals, a processing delay, or the number of TDCP reports.

In some embodiments, a time interval corresponding to the TDCP report is different from a timer interval of TRS.

In some embodiments, the TDCP report comprises a plurality of correlations on different time intervals, and wherein the TDCP report comprises at least one of: an absolute value for each of the plurality of correlations, or an absolute value for a first correlation of the plurality of correlations and a differential value for other correlations in the plurality of correlations.

In some embodiments, at least one of: a value range, a bit size, or a step size for different fields for different correlations in the TDCP report is different.

In some embodiments, a value range for (n+1)-th correlation in the plurality of correlations depends on a value for n-th correlation or a value for a first correlation in the plurality of correlations, wherein n is an integer.

In some embodiments, the TDCP report comprises a plurality of correlations on different time intervals and a doppler parameter, and wherein the doppler parameter comprises at least one of: the maximum doppler shift, the doppler spread, or the coherence time.

In some embodiments, at least one of: a value range, a bit size, or a step size for different fields for different correlations in the TDCP report depends on the doppler parameter.

In some embodiments, the TDCP report comprises the plurality of time intervals corresponding to the plurality of correlation values, and each time interval corresponds to a correlation value.

In some embodiments, the TDCP report comprises at least one of: an absolute value for each time interval; or an absolute value for a first time interval of the plurality of time intervals and a differential value for other time intervals in the plurality of time intervals.

In some embodiments, a value range for (n+1)-th time interval in the plurality of time intervals depends on a value for n-th time interval or a value for a first time interval in the plurality of time intervals, wherein n is an integer.

In one solution, the TDCP report comprises the plurality of time intervals corresponding to the plurality of correlation values and at least one of: a unit of time interval, an indication of whether there is an intra-set correlation, or an indication of intra-set or inter-set correlation.

In some embodiments, at least one of: a value range, a bit size, or a step size for different fields for different time intervals depends on the unit of time interval.

In some embodiments, the TDCP report comprises a plurality of doppler shifts, and wherein the plurality of doppler shifts are arranged in an increasing order of delays of multiple paths.

In some embodiments, the TDCP report comprises at least one of: an absolute value for each of the plurality of doppler shifts, or an absolute value for a first doppler shift of the plurality of doppler shifts and (n+1) doppler shift is a differential value related to the first doppler shift or related to n-th doppler shift, wherein n is an integer; or wherein the TDCP report comprises a unit of doppler shift, and each of the plurality of doppler shifts is based on the unit of doppler shift and a corresponding doppler shift field value in the TDCP report.

In some embodiments, the TDCP report has a higher priority than a channel state information (CSI) report.

In some embodiments, the TDCP comprises at least one correlation or indication that is associated with a CSI reference signal (CSI-RS) or CSI configuration.

In some embodiments, a first processing time for the TDCP report comprises at least one of: a total number of CSI-RS resources in multiple TRS sets for the TDCP report, a total number of time intervals for the TDCP report, a number of CSI-RS resources in a TRS set for the TDCP report multiplying a value, wherein the value is configured by the network device or preconfigured.

In some embodiments, a second processing time for coherent joint transmission (CJT) comprises a combination of a number of central processing units (CPUs) occupied by a set of CSI-RS resources for CJT and a second value, wherein the second value is 0 or a number of single-transmission reception point (TRP) hypothesis.

In some embodiments, a third processing time for a velocity processing comprises a combination of a number of CPUs occupied by a set of CSI-RS resource for the velocity and a third value, or wherein the third processing time comprises a combination of a number of CSI-RS occasions in a CSI-RS set for the velocity and the third value, and wherein the third value is a predetermined number.

In some embodiments, a network device comprises a circuitry configured to perform: receiving, from a terminal device, a time domain channel properties (TDCP) report comprising a set of parameters, wherein the set of parameters comprises at least one of: a maximum doppler shift, a doppler spread, a coherence time, a speed of the terminal device, correlation information on a plurality of time intervals among resources or resource sets for the TDCP report, an indication of the plurality of time intervals corresponding to a plurality of correlation values, or a unit of time interval, and wherein at least one of a value range, a step size or a number of bits for a first parameter from the set of parameters is based on at least one of a value of or a value range for a second parameter from the set of parameters.

In some embodiments, the correlation information on the plurality of time intervals comprises at least one of: an indication of the plurality of time intervals, a plurality of correlations on the plurality of time intervals, or a number of the plurality of correlations.

In some embodiments, a second correlation value or a range of the second correlation value or a step size of a range of the second correlation value on a second time interval is based on a first correlation value on a first time interval.

In some embodiments, at least one of: the plurality of time intervals or the unit of time interval is based on one of: the maximum doppler shift, the doppler spread, the coherence time, or a first correlation.

In some embodiments, the plurality of time intervals are preconfigured or configured by the network device, or wherein the plurality of time intervals are determined based on an interval between different tracking reference signal (TRS) sets or based on an interval between different TRS symbols within a TRS set.

In some embodiments, the plurality of correlation values are preconfigured or configured by the network device.

In some embodiments, the TDCP report corresponds to a group of TRS sets.

In some embodiments, a user equipment (UE) capability indicates at least one of: whether the terminal device supports the TDCP support, the number of correlations, the maximum number of time intervals, a processing delay, or the number of TDCP reports.

In some embodiments, a time interval corresponding to the TDCP report is different from a timer interval of TRS.

In some embodiments, the TDCP report comprises a plurality of correlations on different time intervals, and wherein the TDCP report comprises at least one of: an absolute value for each of the plurality of correlations, or an absolute value for a first correlation of the plurality of correlations and a differential value for other correlations in the plurality of correlations.

In some embodiments, at least one of: a value range, a bit size, or a step size for different fields for different correlations in the TDCP report is different.

In some embodiments, a value range for (n+1)-th correlation in the plurality of correlations depends on a value for n-th correlation or a value for a first correlation in the plurality of correlations, wherein n is an integer.

In some embodiments, the TDCP report comprises a plurality of correlations on different time intervals and a doppler parameter, and wherein the doppler parameter comprises at least one of: the maximum doppler shift, the doppler spread, or the coherence time.

In some embodiments, at least one of: a value range, a bit size, or a step size for different fields for different correlations in the TDCP report depends on the doppler parameter.

In some embodiments, the TDCP report comprises the plurality of time intervals corresponding to the plurality of correlation values, and each time interval corresponds to a correlation value.

In some embodiments, the TDCP report comprises at least one of: an absolute value for each time interval; or an absolute value for a first time interval of the plurality of time intervals and a differential value for other time intervals in the plurality of time intervals.

In some embodiments, a value range for (n+1)-th time interval in the plurality of time intervals depends on a value for n-th time interval or a value for a first time interval in the plurality of time intervals, wherein n is an integer.

In some embodiments, the TDCP report comprises the plurality of time intervals corresponding to the plurality of correlation values and at least one of: a unit of time interval, an indication of whether there is an intra-set correlation, or an indication of intra-set or inter-set correlation.

In some embodiments, at least one of: a value range, a bit size, or a step size for different fields for different time intervals depends on the unit of time interval.

In some embodiments, the TDCP report comprises a plurality of doppler shifts, and wherein the plurality of doppler shifts are arranged in an increasing order of delays of multiple paths.

In some embodiments, the TDCP report comprises at least one of: an absolute value for each of the plurality of doppler shifts, or an absolute value for a first doppler shift of the plurality of doppler shifts and (n+1) doppler shift is a differential value related to the first doppler shift or related to n-th doppler shift, wherein n is an integer; or wherein the TDCP report comprises a unit of doppler shift, and each of the plurality of doppler shifts is based on the unit of doppler shift and a corresponding doppler shift field value in the TDCP report.

In some embodiments, the TDCP report has a higher priority than a channel state information (CSI) report.

In some embodiments, the TDCP comprises at least one correlation or indication that is associated with a CSI reference signal (CSI-RS) or CSI configuration.

In some embodiments, a first processing time for the TDCP report comprises at least one of: a total number of CSI-RS resources in multiple TRS sets for the TDCP report, a total number of time intervals for the TDCP report, a number of CSI-RS resources in a TRS set for the TDCP report multiplying a value, wherein the value is configured by the network device or preconfigured.

In some embodiments, a second processing time for coherent joint transmission (CJT) comprises a combination of a number of central processing units (CPUs) occupied by a set of CSI-RS resources for CJT and a second value, wherein the second value is 0 or a number of single-transmission reception point (TRP) hypothesis.

In some embodiments, a third processing time for a velocity processing comprises a combination of a number of CPUs occupied by a set of CSI-RS resource for the velocity and a third value, or wherein the third processing time comprises a combination of a number of CSI-RS occasions in a CSI-RS set for the velocity and the third value, and wherein the third value is a predetermined number.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a method of communication comprises: transmitting, at a terminal device and to a network device, a time domain channel properties (TDCP) report comprising a set of parameters, wherein the set of parameters comprises at least one of: a maximum doppler shift, a doppler spread, a coherence time, a speed of the terminal device, correlation information on a plurality of time intervals among resources or resource sets for the TDCP report, an indication of the plurality of time intervals corresponding to a plurality of correlation values, or a unit of time interval, and wherein at least one of a value range, a step size or a number of bits for a first parameter from the set of parameters is based on at least one of a value of or a value range for a second parameter from the set of parameters.

In one solution, the correlation information on the plurality of time intervals comprises at least one of: an indication of the plurality of time intervals, a plurality of correlations on the plurality of time intervals, or a number of the plurality of correlations.

In one solution, a second correlation value or a range of the second correlation value or a step size of a range of the second correlation value on a second time interval is based on a first correlation value on a first time interval.

In one solution, at least one of: the plurality of time intervals or the unit of time interval is based on one of: the maximum doppler shift, the doppler spread, the coherence time, or a first correlation.

In one solution, the plurality of time intervals are preconfigured or configured by the network device, or wherein the plurality of time intervals are determined based on an interval between different tracking reference signal (TRS) sets or based on an interval between different TRS symbols within a TRS set.

In one solution, the plurality of correlation values are preconfigured or configured by the network device.

In one solution, the TDCP report corresponds to a group of TRS sets.

In one solution, a user equipment (UE) capability indicates at least one of: whether the terminal device supports the TDCP support, the number of correlations, the maximum number of time intervals, a processing delay, or the number of TDCP reports.

In one solution, a time interval corresponding to the TDCP report is different from a timer interval of TRS.

In one solution, the TDCP report comprises a plurality of correlations on different time intervals, and wherein the TDCP report comprises at least one of: an absolute value for each of the plurality of correlations, or an absolute value for a first correlation of the plurality of correlations and a differential value for other correlations in the plurality of correlations.

In one solution, at least one of: a value range, a bit size, or a step size for different fields for different correlations in the TDCP report is different.

In one solution, a value range for (n+1)-th correlation in the plurality of correlations depends on a value for n-th correlation or a value for a first correlation in the plurality of correlations, wherein n is an integer.

In one solution, the TDCP report comprises a plurality of correlations on different time intervals and a doppler parameter, and wherein the doppler parameter comprises at least one of: the maximum doppler shift, the doppler spread, or the coherence time.

In one solution, at least one of: a value range, a bit size, or a step size for different fields for different correlations in the TDCP report depends on the doppler parameter. In one solution, the TDCP report comprises the plurality of time intervals corresponding to the plurality of correlation values, and each time interval corresponds to a correlation value.

In one solution, the TDCP report comprises at least one of: an absolute value for each time interval; or an absolute value for a first time interval of the plurality of time intervals and a differential value for other time intervals in the plurality of time intervals.

In one solution, a value range for (n+1)-th time interval in the plurality of time intervals depends on a value for n-th time interval or a value for a first time interval in the plurality of time intervals, wherein n is an integer.

In one solution, the TDCP report comprises the plurality of time intervals corresponding to the plurality of correlation values and at least one of: a unit of time interval, an indication of whether there is an intra-set correlation, or an indication of intra-set or inter-set correlation.

In one solution, at least one of: a value range, a bit size, or a step size for different fields for different time intervals depends on the unit of time interval.

In one solution, the TDCP report comprises a plurality of doppler shifts, and wherein the plurality of doppler shifts are arranged in an increasing order of delays of multiple paths.

In one solution, the TDCP report comprises at least one of: an absolute value for each of the plurality of doppler shifts, or an absolute value for a first doppler shift of the plurality of doppler shifts and (n+1) doppler shift is a differential value related to the first doppler shift or related to n-th doppler shift, wherein n is an integer; or wherein the TDCP report comprises a unit of doppler shift, and each of the plurality of doppler shifts is based on the unit of doppler shift and a corresponding doppler shift field value in the TDCP report.

In one solution, the TDCP report has a higher priority than a channel state information (CSI) report.

In one solution, the TDCP comprises at least one correlation or indication that is associated with a CSI reference signal (CSI-RS) or CSI configuration.

In one solution, a first processing time for the TDCP report comprises at least one of: a total number of CSI-RS resources in multiple TRS sets for the TDCP report, a total number of time intervals for the TDCP report, a number of CSI-RS resources in a TRS set for the TDCP report multiplying a value, wherein the value is configured by the network device or preconfigured.

In one solution, a second processing time for coherent joint transmission (CJT) comprises a combination of a number of central processing units (CPUs) occupied by a set of CSI-RS resources for CJT and a second value, wherein the second value is 0 or a number of single-transmission reception point (TRP) hypothesis.

In one solution, a third processing time for a velocity processing comprises a combination of a number of CPUs occupied by a set of CSI-RS resource for the velocity and a third value, or wherein the third processing time comprises a combination of a number of CSI-RS occasions in a CSI-RS set for the velocity and the third value, and wherein the third value is a predetermined number.

In another solution, a device of communication comprises: a processor configured to cause the device to perform any of the methods above.

In one solution, a method of communication comprises: receiving, at a network device and from a terminal device, a time domain channel properties (TDCP) report comprising a set of parameters, wherein the set of parameters comprises at least one of: a maximum doppler shift, a doppler spread, a coherence time, a speed of the terminal device, correlation information on a plurality of time intervals among resources or resource sets for the TDCP report, an indication of the plurality of time intervals corresponding to a plurality of correlation values, or a unit of time interval, and wherein at least one of a value range, a step size or a number of bits for a first parameter from the set of parameters is based on at least one of a value of or a value range for a second parameter from the set of parameters.

In one solution, the correlation information on the plurality of time intervals comprises at least one of: an indication of the plurality of time intervals, a plurality of correlations on the plurality of time intervals, or a number of the plurality of correlations.

In one solution, a second correlation value or a range of the second correlation value or a step size of a range of the second correlation value on a second time interval is based on a first correlation value on a first time interval.

In one solution, at least one of: the plurality of time intervals or the unit of time interval is based on one of: the maximum doppler shift, the doppler spread, the coherence time, or a first correlation.

In one solution, the plurality of time intervals are preconfigured or configured by the network device, or wherein the plurality of time intervals are determined based on an interval between different tracking reference signal (TRS) sets or based on an interval between different TRS symbols within a TRS set.

In one solution, the plurality of correlation values are preconfigured or configured by the network device.

In one solution, the TDCP report corresponds to a group of TRS sets.

In one solution, a user equipment (UE) capability indicates at least one of: whether the terminal device supports the TDCP support, the number of correlations, the maximum number of time intervals, a processing delay, or the number of TDCP reports.

In one solution, a time interval corresponding to the TDCP report is different from a timer interval of TRS.

In one solution, the TDCP report comprises a plurality of correlations on different time intervals, and wherein the TDCP report comprises at least one of: an absolute value for each of the plurality of correlations, or an absolute value for a first correlation of the plurality of correlations and a differential value for other correlations in the plurality of correlations.

In one solution, at least one of: a value range, a bit size, or a step size for different fields for different correlations in the TDCP report is different.

In one solution, a value range for (n+1)-th correlation in the plurality of correlations depends on a value for n-th correlation or a value for a first correlation in the plurality of correlations, wherein n is an integer.

In one solution, the TDCP report comprises a plurality of correlations on different time intervals and a doppler parameter, and wherein the doppler parameter comprises at least one of: the maximum doppler shift, the doppler spread, or the coherence time.

In one solution, at least one of: a value range, a bit size, or a step size for different fields for different correlations in the TDCP report depends on the doppler parameter.

In one solution, the TDCP report comprises the plurality of time intervals corresponding to the plurality of correlation values, and each time interval corresponds to a correlation value.

In one solution, the TDCP report comprises at least one of: an absolute value for each time interval; or an absolute value for a first time interval of the plurality of time intervals and a differential value for other time intervals in the plurality of time intervals.

In one solution, a value range for (n+1)-th time interval in the plurality of time intervals depends on a value for n-th time interval or a value for a first time interval in the plurality of time intervals, wherein n is an integer.

In one solution, the TDCP report comprises the plurality of time intervals corresponding to the plurality of correlation values and at least one of: a unit of time interval, an indication of whether there is an intra-set correlation, or an indication of intra-set or inter-set correlation.

In one solution, at least one of: a value range, a bit size, or a step size for different fields for different time intervals depends on the unit of time interval.

In one solution, the TDCP report comprises a plurality of doppler shifts, and wherein the plurality of doppler shifts are arranged in an increasing order of delays of multiple paths.

In one solution, the TDCP report comprises at least one of: an absolute value for each of the plurality of doppler shifts, or an absolute value for a first doppler shift of the plurality of doppler shifts and (n+1) doppler shift is a differential value related to the first doppler shift or related to n-th doppler shift, wherein n is an integer; or wherein the TDCP report comprises a unit of doppler shift, and each of the plurality of doppler shifts is based on the unit of doppler shift and a corresponding doppler shift field value in the TDCP report.

In one solution, the TDCP report has a higher priority than a channel state information (CSI) report.

In one solution, the TDCP comprises at least one correlation or indication that is associated with a CSI reference signal (CSI-RS) or CSI configuration.

In one solution, a first processing time for the TDCP report comprises at least one of: a total number of CSI-RS resources in multiple TRS sets for the TDCP report, a total number of time intervals for the TDCP report, a number of CSI-RS resources in a TRS set for the TDCP report multiplying a value, wherein the value is configured by the network device or preconfigured.

In one solution, a second processing time for coherent joint transmission (CJT) comprises a combination of a number of central processing units (CPUs) occupied by a set of CSI-RS resources for CJT and a second value, wherein the second value is 0 or a number of single-transmission reception point (TRP) hypothesis.

In one solution, a third processing time for a velocity processing comprises a combination of a number of CPUs occupied by a set of CSI-RS resource for the velocity and a third value, or wherein the third processing time comprises a combination of a number of CSI-RS occasions in a CSI-RS set for the velocity and the third value, and wherein the third value is a predetermined number.

In another solution, a device of communication comprises: a processor configured to cause the device to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A communication method, comprising:
transmitting, at a terminal device and to a network device, a time domain channel properties (TDCP) report comprising a set of parameters,
wherein the set of parameters comprises at least one of:
a maximum doppler shift,
a doppler spread,
a coherence time,
a speed of the terminal device,
correlation information on a plurality of time intervals among resources or resource sets for the TDCP report,
an indication of the plurality of time intervals corresponding to a plurality of correlation values, or
a unit of time interval, and
wherein at least one of a value range, a step size or a number of bits for a first parameter from the set of parameters is based on at least one of a value of or a value range for a second parameter from the set of parameters.

2. The method of claim 1, wherein the correlation information on the plurality of time intervals comprises at least one of:
an indication of the plurality of time intervals,
a plurality of correlations on the plurality of time intervals, or
a number of the plurality of correlations.

3. The method of claim 1, wherein a second correlation value or a range of the second correlation value or a step size of a range of the second correlation value on a second time interval is based on a first correlation value on a first time interval.

4. The method of any of claims 1-3, wherein at least one of: the plurality of time intervals or the unit of time interval is based on one of:
the maximum doppler shift,
the doppler spread,
the coherence time, or
a first correlation.

5. The method of claim 1, wherein the TDCP report comprises a plurality of correlations on different time intervals, and
wherein the TDCP report comprises at least one of:
an absolute value for each of the plurality of correlations, or
an absolute value for a first correlation of the plurality of correlations and a differential value for other correlations in the plurality of correlations.

6. The method of claim 5, wherein at least one of: a value range, a bit size, or a step size for different fields for different correlations in the TDCP report is different.

7. The method of claim 5, wherein a value range for (n+1)-th correlation in the plurality of correlations depends on a value for n-th correlation or a value for a first correlation in the plurality of correlations, wherein n is an integer.

8. The method of claim 1, wherein the TDCP report comprises a plurality of correlations on different time intervals and a doppler parameter, and
wherein the doppler parameter comprises at least one of: the maximum doppler shift, the doppler spread, or the coherence time.

9. The method of claim 8, wherein at least one of: a value range, a bit size, or a step size for different fields for different correlations in the TDCP report depends on the doppler parameter.

10. The method of claim 1, wherein the TDCP report comprises the plurality of time intervals corresponding to the plurality of correlation values, and each time interval corresponds to a correlation value.

11. The method of claim 10, wherein the TDCP report comprises at least one of:
an absolute value for each time interval; or
an absolute value for a first time interval of the plurality of time intervals and a differential value for other time intervals in the plurality of time intervals.

12. The method of claim 10, wherein a value range for (n+1)-th time interval in the plurality of time intervals depends on a value for n-th time interval or a value for a first time interval in the plurality of time intervals, wherein n is an integer.

13. The method of claim 1, wherein the TDCP report comprises the plurality of time intervals corresponding to the plurality of correlation values and at least one of: a unit of time interval, an indication of whether there is an intra-set correlation, or an indication of intra-set or inter-set correlation.

14. The method of claim 13, wherein at least one of: a value range, a bit size, or a step size for different fields for different time intervals depends on the unit of time interval.

15. The method of claim 1, wherein the TDCP report comprises a plurality of doppler shifts, and
wherein the plurality of doppler shifts are arranged in an increasing order of delays of multiple paths.

16. The method of claim 15, wherein the TDCP report comprises at least one of:
an absolute value for each of the plurality of doppler shifts, or
an absolute value for a first doppler shift of the plurality of doppler shifts and (n+1) doppler shift is a differential value related to the first doppler shift or related to n-th doppler shift, wherein n is an integer; or
wherein the TDCP report comprises a unit of doppler shift, and each of the plurality of doppler shifts is based on the unit of doppler shift and a corresponding doppler shift field value in the TDCP report.

17. The method of claim 1, wherein the TDCP comprises at least one correlation or indication that is associated with a CSI reference signal (CSI-RS) or CSI configuration.

18. The method of claim 1, wherein a first processing time for the TDCP report comprises at least one of:
a total number of CSI-RS resources in multiple TRS sets for the TDCP report,
a total number of time intervals for the TDCP report,
a number of CSI-RS resources in a TRS set for the TDCP report multiplying a value, wherein the value is configured by the network device or preconfigured.

19. A terminal device comprising:
a processor; and
a memory coupled to the processor and storing instructions thereon, the instructions, when executed by the processor, causing the terminal device to perform acts comprising the method according to any of claims 1-18.

20. A computer readable medium having instructions stored thereon, the instructions, when executed on at least one processor, causing the at least one processor to perform the method according to any of claims 1-18.
